(19) United States
(12) Patent Application Publication
(10) Pub. No.: US 2026/0015465 A1
(43) Pub. Date: Jan. 15, 2026

(54) COATING COMPOSITIONS WITH POLYSILOXANE-MODIFIED CARBON NANOPARTICLE

(71) Applicant: NGNT MATERIAL SCIENCES S.A., POMY (CH)

(72) Inventors: Andrey Vladimirovich BAZUROV, Moscow (RU); Igor Nikolaevich KULESHOV, Kryukovo (RU)

(73) Assignee: NGNT MATERIAL SCIENCES S.A., POMY (CH)

(21) Appl. No.: 19/335,530

(22) Filed: Sep. 22, 2025

Related U.S. Application Data
(63) Continuation of application No. 17/629,632, filed on Jan. 24, 2022, now abandoned.
(60) Provisional application No. 62/878,487, filed on Jul. 25, 2019.

(51) Int. Cl. C08G 77/62; C08K 3/04; C08K 9/00; C09D 7/62

(52) U.S. Cl. CPC C08G 77/62; C08K 3/04; C08K 9/00; C09D 7/62; C08K 2201/005; C08K 2201/011

(57) ABSTRACT

A composition comprising a silicon-based polymer, and a derivatized carbon nano-particle is provided. Further, a method for coating a substrate, coated substrates and articles comprising a substrate coated with the composition are provided.

### CROSS-REFERENCE TO RELATED APPLICATIONS

This application is a Continuation of a U.S. patent application Ser. No. 17/629,632 filed Jan. 24, 2022, which is a national phase of PCT Patent Application No. PCT/IB2020/057047 having International filing date of Jul. 26, 2020, which claims the benefit of priority of U.S. Provisional Patent Application No. 62/878,487 filed Jul. 25, 2019, the contents of which are all incorporated herein by reference in their entirety.

### FIELD OF THE INVENTION

The present invention is in the field of carbon nano-particle/polymer compositions, processes of preparing such compositions and uses thereof.

### BACKGROUND OF THE INVENTION

Self-cleaning surfaces are a class of materials with the inherent ability to remove any debris or bacteria from their surfaces in a variety of ways. The majority of self-cleaning surfaces can be placed into three categories: 1) Superhydrophobic, 2) Superhydrophilic, and 3) Photocatalytic.

Superhydrophobic surfaces have received rapidly increasing research interest because of their tremendous application potential in areas such as self-cleaning and anti-icing surfaces, along with chemical resistance and enhanced heat transfer. A surface is considered superhydrophobic if a water droplet beads up (with contact angles>140°), and moreover, if the droplet can slide away from the surface readily (i.e., it has small contact angle hysteresis). This behavior, known as the lotus or self-cleaning effect, is found to be a result of the hierarchical rough structure, as well as the wax layer present on the leaf surface.

Superhydrophobic surfaces may exhibit additional properties, such as oleophobicity. A surface, providing a combination of hydrophobic and oleophobic properties is considered as lyophobic. Increasing the hydrophobicity of a silicon-polymer based coating by using conventional approaches may impair other surface properties, such as surface wear resistance, tensile strength, and may also reduce cohesion and adhesion to the substrate surface. Therefore, preparation of highly stable durable coatings, providing anti-abrasive properties to a surface on the one hand, together with oleophobic, and anti-corrosive properties on the other hand, is still a great challenge. There is a demand for new easy-to-apply compositions and coatings, having improved mechanical and functional properties.

### SUMMARY OF THE INVENTION

According to one aspect, there is provided a composition, comprising: a silicon-based polymer, and a derivatized carbon nano-particle, wherein the derivatized carbon nano-particle comprises a functional moiety attached to the derivatized carbon nano-particle by a covalent bond, and wherein the silicon-based polymer is represented by Formula 1:

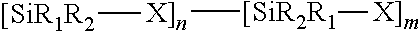

wherein:
n and m are integers ranging from 100 to 150000;
X is selected from the group consisting of: N, NH, and O, or any combination thereof;
R₁, R₂ or both are selected from the group comprising: hydrogen, an alkyl group, an alkoxy group, a thioalkoxy group, an aryl group, a fused ring, an alkaryl group, a heteroaryl group, a cycloalkyl group, an aryloxy group, a thioaryloxy group, an ether group, and a halo group or any combination thereof.

In some embodiments, the functional moiety is selected from the group comprising: a halo group, a haloalkyl group, hydrogen, a hydroxy group, a mercapto group, an amino group, an aryl group, an alkyl group, a cycloalkyl group, an alkaryl group, an ether group, and a hydrophobic polymer or any combination thereof.

In some embodiments, R₁, R₂ or both are selected from the group comprising: hydrogen, fluorine, an alkyl group, an aryl group, a heteroaryl group, and a cycloalkyl group or any combination thereof.

In some embodiments, the silicon-based polymer comprises an adhesiveness property to a surface.

In some embodiments, the adhesiveness property comprises a covalent or a non-covalent bond formation.

In some embodiments, the silicon-based polymer has a molecular weight ranging from 150 to 150000 g/mol.

In some embodiments, the functional moiety comprises a halo group, or a haloalkyl group.

In some embodiments, the functional moiety is fluoro.

In some embodiments, the derivatized carbon nano-particle is characterized by a median particle size of 1 to 600 nm.

In some embodiments, a substitution degree of the derivatized carbon nano-particle is between 10 and 99.9 atomic percent.

In some embodiments, the derivatized carbon nano-particle is characterized by a surface water contact angle of more than 40°.

In some embodiments, the derivatized carbon nano-particle is selected from the group comprising: a derivatized nano-tube, a derivatized nano-rod, and a derivatized nano-diamond or any combination thereof.

In some embodiments, a weight per weight (w/w) concentration of the silicon-based polymer within the composition is 0.01 to 90%.

In some embodiments, a w/w concentration of the derivatized carbon nano-particle within the composition is 0.001 to 70%.

In some embodiments, the composition comprises a plurality of derivatized carbon nano-particles.

In some embodiments, the silicon-based polymer is perhydrosilazane, and wherein said derivatized carbon nano-particle comprises a fluorinated nano-diamond, a fluorinated SWCNT or both.

In some embodiments, the composition further comprises a solvent which is inert to the silicon-based polymer.

In some embodiments, the solvent is selected from an aromatic solvent, and an aliphatic solvent or any combination thereof.

In some embodiments, the composition is for use as: an anti-fouling coating, an anti-corrosion coating, a UV-protective coating, a heat resistant coating, a chemical resistant coating, a superhydrophobic coating, a lyophobic coating, an anti-abrasive coating, a self-cleaning coating.

According to one aspect, there is provided an article, comprising a coating layer, the coating layer comprises the composition of the present invention.

In some embodiments, the article comprises a fragile surface a flexible surface, an expandable surface or any combination thereof.

According to one aspect, there is provided a coated substrate, comprising a substrate, a silicon-based polymer, and a derivatized carbon nano-particle, wherein the silicon-based polymer is bound to at least a portion of the substrate, the derivatized carbon nano-particle is in contact with the silicon-based polymer, and wherein the derivatized carbon nano-particle and the silicon-based polymer are forming a coating layer.

In some embodiments, the coated substrate further comprises a plurality of coating layers.

In some embodiments, the coating layer is characterized by an average thickness of 0.1 μm to 400 μm.

In some embodiments, the silicon-based polymer and the derivatized carbon nano-particle are as described in the present invention.

In some embodiments, the coating layer is characterized by a surface contact angle of more than 40°.

In some embodiments, the coating layer is stable at a temperature range of −100 to 1500° C.

In some embodiments, the coating layer is characterized by hardness of between 0.1 and 15 GPa, wherein said hardness is measured by nanoindentation according to ISO 14577 test.

In some embodiments, the substrate is selected from the group comprising: a polymeric substrate, a metallic substrate, a paper substrate, a wood substrate and a glass substrate or any combination thereof.

In some embodiments, the substrate is further coated with a lacquer, a varnish or a paint.

According to one aspect, there is provided a method of coating a substrate, comprising the steps of: i) providing a substrate; ii) contacting the substrate with the composition of the invention, thereby forming a coating layer on the substrate.

In some embodiments, the contacting is selected from the group comprising: dipping, spraying, spreading, casting, rolling, adhering, and curing or any combination thereof.

In some embodiments, the substrate is selected from the group comprising: a polymeric substrate, a metallic substrate, a ceramic substrate, and a glass substrate or any combination thereof.

In some embodiments, the substrate is further coated with a lacquer, a varnish or a paint.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIGS. 1A-B present water contact angle images of a surface coated by fluorinated nano-diamonds (FIG. 1A) showing a contact angle of ca. 146°, and by non-derivatized nano-diamonds (FIG. 1B), showing a contact angle of ca. 16°, as measured by a tensiometer (OCA 20 DATAPHYSICS INSTRUMENTS GMBH).

FIGS. 2A-B present contact angle images of a substrate coated with 0.5-10% perhydrosilazane (FIG. 2A) showing a contact angle of ca. 33°, versus a substrate coated with an exemplary composition of the invention, consisting of 0.5-5 weight % perhydrosilazane and 0.001-0.1 weight % derivatized nano-diamonds (FIG. 2B), showing a contact angle of ca. 102°. The images were measured by a tensiometer (OCA 20 DATAPHYSICS INSTRUMENTS GMBH).

FIGS. 3A-B present cross-section Scanning Electron Microscope (SEM) images of a substrate before (FIG. 3A) and after (FIG. 3B) coating with a composition of the invention exhibiting a coating thickness of about 35 μm.

### DETAILED DESCRIPTION OF THE INVENTION

The present invention, in some embodiments thereof, relates to a composition comprising a plurality of derivatized or surface-modified carbon nano-particles and a silicon-based polymer, processes of preparing such compositions and to uses thereof. The present invention, in some embodiments thereof, relates to a coating composition comprising a plurality of derivatized carbon nano-particles and a silicon-based polymer, processes of preparing such compositions and to uses thereof. In some embodiments, the silicon-based polymer is selected from polysilazane and polysiloxane.

The present invention, in some embodiments thereof, relates to a process for coating a substrate with the composition comprising a plurality of derivatized carbon nano-particles and a silicon-based polymer, without the presence of an additional non silicon-based polymer. The present invention, in some embodiments thereof, relates to a process for coating a substrate with the coating composition comprising a plurality of derivatized carbon nano-particles and a silicon-based polymer, without the presence of an additional non silicon-based polymer. In some embodiments, the silicon-based polymer provides an adhesiveness property to the coating, enhancing a thickness and/or stability of a coating layer. In some embodiments, the derivatized carbon nano-particle is selected from the group comprising: a derivatized nano-tube, a derivatized nano-rod, a derivatized nano-diamond or any combination thereof.

In some embodiments, the substrate is selected from a hydrophilic substrate (such as a metallic substrate or a glass substrate), and a hydrophobic substrate (such as a polymeric substrate) or alternatively, a surface of the substrate is at least partially coated with a lacquer, a varnish or a paint.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

### The Composition

According to one aspect, there is provided a composition, comprising: a silicon-based polymer, and a derivatized carbon nano-particle. In some embodiments, the silicon-based polymer is represented by Formula 1:

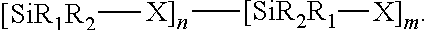

In some embodiments, n and m are integers ranging from 100 to 150000. In some embodiments, n and m are integers ranging from 100 to 120000, 100 to 100000, 100 to 90000, 100 to 70000, 100 to 50000, 100 to 40000, 100 to 30000, 100 to 30000, 100 to 10000, 100 to 9000, 100 to 8000, 100 to 5000, 100 to 4000, 100 to 3000, 100 to 2000, 200 to 150000, 500 to 150000100 to 150000, 1000 to 150000, 2000 to 150000, 5000 to 150000, 10000 to 150000, 500 to 100000, 500 to 90000, 500 to 70000, 500 to 50000, 500 to 40000, 500 to 30000, 500 to 30000, 500 to 10000, 500 to 9000, 500 to 8000, or 500 to 5000, including any range therebetween. In some embodiments, X is selected from the group comprising: N, NH, and O, or any combination thereof.

In some embodiments, R₁, R₂ or both are selected from the group comprising: hydrogen, an alkyl group, an alkoxy group, a thioalkoxy group, an aryl group, a fused ring, an alkaryl group, a heteroaryl group, a cycloalkyl group, an aryloxy group, a thioaryloxy group, an ether group, and a halo group or any combination thereof.

In some embodiments, the silicon-based polymer is a polysiloxane represented by Formula 2: [—SiR₁R₂—O—]ₙ, or by Formula 2A: R₃—[—SiR₁R₂—O—]ₙ—R₃, wherein R₁ and R₂ are as described herein above, and R₃ is selected from the group comprising: hydrogen, a halo group, an alkoxy group, a hydroxy group, and a bond.

In some embodiments, R₁, R₂ or both are selected from the group comprising: hydrogen, fluorine, and an alkyl group. In some embodiments, R₁, and R₂ are hydrogens.

In some embodiments, the silicon-based polymer is a polysilazane represented by Formula 3: [—SiR₁R₂—NR₄—]ₙ, or by Formula 3A: R′₃—[—SiR₁R₂—NR₄—]ₙ—R₄, wherein R₁, and R₂ are as described herein above, and R₄ is selected from the group comprising: hydrogen, and a bond. In some embodiments, R′₃ is selected from the group comprising: hydrogen, a hydroxy group, a halo group, an amino group, a bond, and an alkoxy group.

In some embodiments, the silicon-based polymer is a co-polymer of polysilazane and polysiloxane, represented by Formula 4:

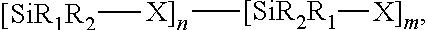

wherein R₁, and R₂ are as described herein above.

In some embodiments, the silicon-based polymer is perhydropolysilazane represented by Formula 5: [—SiH₂—NR₄—]ₙ, or by Formula 5A: R′₃—[—SiH₂—NR₄—]ₙ—R₄, wherein R′₃ and R₄ are as described herein above.

In some embodiments, the silicon-based polymer is a derivatized perhydropolysilazane. In some embodiments, a derivatized perhydropolysilazane is fluorinated perhydropolysilazane, wherein at least a part of hydrogen atoms is replaced by fluorine atoms. In some embodiments, the ratio of fluorine atoms to hydrogen atoms in the polymer ranges from 1 to 50%, from 1 to 10%, from 10 to 20%, from 20 to 30%, from 30 to 40%, from 40 to 50%, or any value there between.

In some embodiments, the coating composition comprises a mixture of silicon-based polymers, wherein the silicon-based polymers are selected from Formulae 1-5 or from Formulae 2A, 3A, 5A, as described herein above. In some embodiments, the coating composition comprises silicon carbide.

In some embodiments, the silicon-based polymer has an average molecular weight ranging from 1500 g/mol to 150000 g/mol. In some embodiments, the silicon-based polymer has an average molecular weight ranging from 1700 g/mol to 150000 g/mol, 1900 g/mol to 150000 g/mol, 2000 g/mol to 150000 g/mol, 2500 g/mol to 150000 g/mol, 4000 g/mol to 150000 g/mol, 5000 g/mol to 150000 g/mol, 7000 g/mol to 150000 g/mol, 10000 g/mol to 150000 g/mol, 20000 g/mol to 150000 g/mol, 50000 g/mol to 150000 g/mol, 70000 g/mol to 150000 g/mol, 100000 g/mol to 150000 g/mol, 1500 g/mol to 100000 g/mol, 1500 g/mol to 80000 g/mol, 1500 g/mol to 50000 g/mol, 1500 g/mol to 20000 g/mol, 1500 g/mol to 10000 g/mol, 2000 g/mol to 100000 g/mol, 2000 g/mol to 80000 g/mol, 2000 g/mol to 50000 g/mol, 2000 g/mol to 20000 g/mol, 2000 g/mol to 10000 g/mol, 5000 g/mol to 100000 g/mol, 5000 g/mol to 80000 g/mol, 5000 g/mol to 50000 g/mol, 5000 g/mol to 20000 g/mol, or 5000 g/mol to 10000 g/mol, including any range therebetween.

In some embodiments, the silicon-based polymer (e.g. polysilazane) is formed in-situ upon application of the substrate. Such in-situ reaction resulting in the formation of polysilazane is well-known in the art and comprises in general a reaction of an amine (such as ammonia or any source or precursor thereof) with an organosilicon (e.g. chloro-silane) under suitable conditions.

In some embodiments, the composition comprises the derivatized carbon nano-particle, a polysiloxane and ammonia, wherein the ratio of polysiloxane and ammonia is sufficient to obtain polysilazane in-situ.

In some embodiments, the coating composition comprises a derivatized carbon nano-particle. In some embodiments, a derivatized carbon nano-particle comprises a functional moiety attached by a covalent bond to a surface of the derivatized carbon nano-particle. In some embodiments, the derivatized carbon nano-particle comprises a plurality of chemically modified surface groups. In some embodiments, the surface of the derivatized carbon nano-particle is at least a partially modified. In some embodiments, the functional moiety comprises a halo group, or a haloalkyl group. In some embodiments, the functional moiety comprises a fluoroalkyl group. In some embodiments, the functional moiety comprises fluorine. In some embodiments, the functional moiety comprises a halo group, a haloalkyl group, an amino group, carboxylic group, a silane group, a silyl group, hydroxy group, a mercapto group, an aryl group, an alkyl group, a cycloalkyl group, an alkaryl group, an ether group, a hydrophobic polymer or any combination thereof. In some embodiments, the derivatized carbon nano-particle is a halogenated carbon nano-particle.

In some embodiments, at least a part of a surface of a carbon nano-particle is chemically modified. In some embodiments, a chemically modified carbon nano-particle is a derivatized carbon nano-particle. In some embodiments, the chemical modification alters the properties of the carbon nano-particle. In some embodiments, a carbon nano-particle after chemical modification becomes hydrophobic. In some embodiments, a carbon nano-particle after chemical modification becomes oleophobic. In some embodiments, a carbon nano-particle after chemical modification becomes lyophobic. In some embodiments, a carbon nano-particle after chemical modification exhibits improved solubility within a solvent. In some embodiments, a carbon nano-particle after chemical modification exhibits an improved dispersion ability within a solvent. In some embodiments, a carbon nano-particle after chemical modification forms improved bonding interactions with a solvent. In some embodiments, a carbon nano-particle after chemical modification forms improved bonding interactions with the silicon-based polymer.

In some embodiments, a substitution degree of the derivatized carbon nano-particle by the functional moiety is between 0.2 and 99.9 atomic percent. In some embodiments, the derivatized carbon nano-particle is derivatized by a halo group (e.g. fluorine), wherein a substitution degree of the derivatized carbon nano-particle is between 0.2 and 99.9 atomic percent, including any range between. In some embodiments, the derivatized carbon nano-particle is substituted by the functional moiety and has a substitution degree of 0.2 to 40, 0.2 to 35, 0.2 to 30, 0.2 to 28, 0.2 to 25, 0.2 to 20, 0.2 to 10, 0.2 to 10, 0.5 to 40, 0.9 to 40, 1 to 40, 2 to 40, 5 to 40, 10 to 40, 15 to 40, 0.2 to 40, 0.5 to 30, 0.9 to 30, 1 to 30, 2 to 30, 5 to 30, 10 to 30, 15 to 30, 0.2 to 30, 0.5 to 25, 0.9 to 25, 1 to 25, 2 to 25, 5 to 25, 10 to 25, 15 to 25, 20 to 40, 40 to 60, 60 to 80, 80 to 90, or 0.2 to 25 atomic percent, including any range therebetween, wherein the functional moiety is as described herein. In some embodiments, the above mentioned substitution degree refers to a percentage of the total amount of H atoms and/or sp²-hybridized carbon atoms within a non-derivatized carbon nano-particle. In some embodiments, the substitution degree refers to a percentage relative to a total non-carbon atom content of the non-derivatized carbon nano-particle. The substitution degree or the atomic percentage of the functional moiety relative to the initial amount of hydrogen atoms and/or of the sp²-hybridized carbon atoms within a non-derivatized carbon nano-particle, may be calculated according to well-known methods, such as NMR, Raman etc. Several method of derivatization (e.g. fluorination) of the carbon nano-particles (up to a substitution degree of almost 100%) are well-known to those skilled in the art.

In some embodiments, the derivatized carbon nano-particle is characterized by a median particle size of 1 nm to 600 nm. In some embodiments, the derivatized carbon nano-particle is characterized by a median particle size of 2 nm to 600 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 1 nm to 50 nm, 1 nm to 5 nm, 5 nm to 10 nm, 10 nm to 20 nm, 20 nm to 50 nm, 100 nm to 200 nm, 200 nm to 40 nm, 400 nm to 500 nm, and 50 nm to 100 nm, including any range therebetween. In some embodiments, the derivatized carbon nano-particle (e.g. the derivatized nano-diamond) is substantially devoid of particles with a median particle size of greater than 100 nm, greater than 200 nm, greater than 300 nm, greater than 400 nm, greater than 500 nm, greater than 600 nm, including any range or value therebetween.

In some embodiments, the size of at least 90% of the particles varies within a range of less than ±25%, ±20%, ±15%, ±19%, ±5%, including any value therebetween.

In some embodiments, the derivatized carbon nano-particle is selected from the group comprising: a derivatized nano-tube (SWCNT and/or MWCNT), a derivatized nano-rod, a derivatized nano-diamond, a derivatized fullerene, a derivatized nanographite, a derivatized graphene, a derivatized graphene fiber, or any combination thereof.

In some embodiments, the composition of the invention comprises a plurality of derivatized carbon nano-particles. In some embodiments, plurality of derivatized carbon nano-particle comprises two or more derivatized carbon nano-particles. In some embodiments, the two or more derivatized carbon nano-particles are different. In some embodiments, the derivatized carbon nano-particle comprises two or more different carbon nano-particles. In some embodiments, the composition of the invention comprises a first derivatized carbon nano-particle and a second derivatized carbon nano-particle. In some embodiments, the composition of the invention comprises a plurality of the first derivatized carbon nano-particles and a plurality of the second derivatized carbon nano-particles.

In some embodiments, there is a composition comprising the silicon-based polymer, and two or more of the derivatized carbon nano-particles, wherein the silicon-based polymer and the derivatized carbon nano-particle are as described herein. In some embodiments, the composition (e.g. the composition of the invention) comprises a first derivatized carbon nano-particle and a second derivatized carbon nano-particle. In some embodiments, the composition of the invention comprises the silicon-based polymer (e.g. polysilazane), and two or more of the derivatized carbon nano-particles. In some embodiments, the composition of the invention comprises the silicon-based polymer (e.g. polysilazane), and two or more of the halogenated carbon nano-particles. In some embodiments, the composition of the invention comprises the silicon-based polymer (e.g. polysilazane), and two or more of the fluorinated carbon nano-particles. In some embodiments, the composition of the invention comprises the silicon-based polymer, and two or more of the derivatized carbon nano-particles, wherein the two or more of the derivatized carbon nano-particles comprise the derivatized nano-diamond and the derivatized carbon nanotube. In some embodiments, the composition of the invention comprises the silicon-based polymer (e.g. polysilazane), a derivatized SWCNT, and a derivatized nano-diamond, wherein the silicon-based polymer, the derivatized SWCNT, and the derivatized nano-diamond are as described herein. In some embodiments, the concentration of the components of the composition of the invention are as described herein. In some embodiments, the two or more of the derivatized carbon nano-particles comprise fluorinated nano-diamonds and fluorinated SWCNTs. Derivatized SWCNT (e.g. fluorinated SWCNT) and derivatized nano-diamonds (e.g. fluorinated nano-diamonds) have been successfully utilized by the inventors for manufacturing of stable compositions and coatings. Liquid compositions comprising the silicon-based polymer; and a plurality of derivatized particles comprising derivatized nano-diamonds (e.g. fluorinated nano-diamonds) and the derivatized carbon nano-tube (e.g. fluorinated SWCNT) at a concentration of the plurality of derivatized particles between 0.1 and 0.4% w/w within the liquid composition have been successfully prepared and implemented by the inventors, such as for coating of a substrate. Other concentrations of the derivatized carbon nano-particle within the composition are currently under study. It is expected, that compositions comprising more than 20%, more than 30%, more than 40%, more than 50%, more than 60%, more than 70%, more than 80%, more than 90% by weight of the derivatized carbon nano-tube, might be in the form of a semi-liquid composition or a semi-solid composition (e.g. gel). Exemplary composition are represented in the Exemplary section.

In some embodiments, a w/w ratio of the first derivatized carbon nano-particle (e.g. derivatized nano-diamond) to the second derivatized carbon nano-particle (e.g. derivatized nano-tube) within the composition of the invention is between 1:10 and 10:1, between 1:1 and 1:2, between 1:2 and 1:3, between 1:3 and 1:5, between 1:5 and 1:7, between 1:7 and 1:10, between 1:1 and 2:1, between 2:1 and 3:1, between 3:1 and 4:1, between 4:1 and 5:1, between 5:1 and 7:1, between 7:1 and 10:1, including any range therebetween.

In some embodiments, a w/w ratio of the derivatized nano-diamond (e.g. fluorinated nano-diamond) to the second derivatized carbon nano-particle (e.g. fluorinated SWCNT) within the composition of the invention is between 1:10 and 10:1, between 1:1 and 1:2, between 1:2 and 1:3, between 1:3 and 1:5, between 1:5 and 1:7, between 1:7 and 1:10, between 1:1 and 2:1, between 2:1 and 3:1, between 3:1 and 4:1, between 4:1 and 5:1, between 5:1 and 7:1, between 7:1 and 10:1, including any range therebetween. In some embodiments, a w/w ratio of the derivatized nano-diamond (e.g. fluorinated nano-diamond) to the second derivatized carbon nano-particle (e.g. fluorinated SWCNT) within the composition is between 2:1 and 1:2, between 2:1 and 1.7:1, between 1.7:1 and 1.5:1, between 1.5:1 and 1.3:1, between 1.3:1 and 1:1, between 1:1 and 1:1.3, between 1:1.3 and 1:1.5, between 1:1.5 and 1:1.7, between 1:1.7 and 1:2, including any range therebetween. In some embodiments, the composition is as described herein.

In some embodiments, a total weight content of the plurality of derivatized carbon nano-particles within the composition of the invention is between 0.05 and 90%, between 0.05 and 0.1%, between 0.1 and 0.2%, between 0.2 and 0.3%, between 0.3 and 0.5%, between 0.5 and 1%, between 1 and 10%, between 10 and 20%, between 20 and 30%, between 30 and 50%, between 50 and 70%, between 70 and 90%, including any range therebetween. In some embodiments, a total weight content of the plurality of derivatized carbon nano-particles (e.g. derivatized nano-diamond and derivatized carbon nano-tube) within the composition of the invention is between 0.05 and 90%, between 0.05 and 0.1%, between 0.1 and 0.2%, between 0.2 and 0.3%, between 0.3 and 0.5%, between 0.5 and 1%, between 1 and 10%, between 10 and 20%, between 20 and 30%, between 30 and 50%, between 50 and 70%, between 70 and 90%, including any range therebetween. In some embodiments, the derivatized nano-diamond and derivatized carbon nano-tube are as described herein. In some embodiments, the derivatized nano-diamond is a fluorinated nano-diamond and the derivatized carbon nano-tube is a fluorinated SWCNT.

In some embodiments, the composition of the invention consists essentially of the silicon based polymer, the derivatized nano-diamond and/or the derivatized carbon nano-tube. In some embodiments, the composition of the invention consists essentially of the silicon based polymer, the derivatized nano-diamond and/or the derivatized carbon nano-tube and the solvent.

In some embodiments, the dry material content of the composition of the invention consists essentially of the silicon based polymer, the derivatized nano-diamond and/or the derivatized carbon nano-tube.

As used herein, “fullerene(s)” may include any of the known cage-like hollow allotropic forms of carbon possessing a polyhedral structure. Fullerenes may include, for example, from about 20 to about 100 carbon atoms. For example, C₆₀ is a fullerene having 60 carbon atoms and high symmetry (D5h), and is a relatively common, commercially available fullerene. Exemplary fullerenes may include C₃₀, C₃₂, C₃₄, C₄₀, C₅₀, C₆₀, C₇₀, C₇₆, and the like.

As used herein, “carbon nanotube(s)” refers to hollow tubular fullerene structures which may be inorganic or made entirely or partially of carbon and may include also components such as metals or metalloids.

Carbon nanotubes may be single walled nanotubes (SWNTs) or multiwalled nanotubes (MWNTs).

As used herein, “carbon nanorod(s)” refers to filled tubular fullerene structures made entirely or partially of carbon. Carbon nanorod(s) may include a filling which is chemically different from the fullerene structured wall.

As used herein, “nanographite” is a cluster of plate-like sheets of graphite, in which a stacked structure of one or more layers of graphite, which has a plate-like two dimensional structure of fused hexagonal rings with an extended delocalized p-electron system, are layered and weakly bonded to one another through p-p stacking interaction.

As used herein, “nanographene” refers to effectively two-dimensional particles of nominal thickness, having of one or more layers of fused hexagonal rings with an extended delocalized p-electron system, layered and weakly bonded to one another through p-p stacking interaction. Nanographene, may be a single sheet or a stack of several sheets having both nano-scale dimensions.

As used herein, “nanodiamond” refers to diamond nanocrystals, a nanodimensioned diamond particle. The term “nanocrystal” and “nanomaterials” means that at least one dimension equal to or less than 1000 nanometers or crystalline materials. “Diamond” as used herein includes both natural and synthetic diamonds from a variety of synthetic processes, as well as “diamond-like carbon” (DLC) in particulate form. The diamond particles have at least one dimension of less than 1 micrometer, less than 800 nm, less than 500 nm, or less than 100 nm, for example 1 nm to about 100 nm or 1 to 500 nm. The particle can be of any shape, e.g., rectangular, spherical, cylindrical, cubic, or irregular, provided that at least one dimension is nanosized, i.e., less than 1 micrometer, less than 800 nm, less than 500 nm, or less than 100 nm. The term “derivatized nanodiamond” refers to nanodiamond particles having organic functional groups on its surface. The terms “functional groups” and “functional moiety” refer to specific substituents or moieties within molecules that are responsible for the characteristic chemical reactions of those molecules.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

In some embodiments, the size of the particles described herein represents an average or median size of a plurality of nanoparticle composites or nanoparticles.

As used herein the terms “average” or “median” size refer to diameter of the carbon nano-particles.

In some embodiments, the average or the median size of at least e.g., 10%, 20%, 30%, 40%, 50%, 60%, 70%, 80%, 90%, or 95% of the particles, ranges from: about 1 nanometer to 1000 nanometers, or, in other embodiments from 1 nm to 500 nm, or, in other embodiments, from 5 nm to 200 nm. In some embodiments, the average or the median size ranges from about 1 nanometer to about 300 nanometers. In some embodiments, the average or the median size ranges from about 1 nanometer to about 200 nanometers. In some embodiments, the average or the median size ranges from about 1 nanometer to about 100 nanometers. In some embodiments, the average or the median size ranges from about 1 nanometer to 50 nanometers, and in some embodiments, it is lower than 35 nm.

In some embodiments, a plurality of the particles has a uniform size.

By “uniform” or “homogenous” it is meant to refer to size distribution that varies within a range of less than e.g., ±60%, ±50%, ±40%, ±30%, ±20%, or ±10%, including any value therebetween.

In some embodiments, the particles size is about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 40 nm, about 42 nm, about 44 nm, about 46 nm, about 48 nm, or 50 nm, including any value therebetween.

As used herein the terms “average” or “median” size refer to diameter of the polymeric particles. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS).

In some embodiments, the dry diameter of the polymeric particles, as prepared according to some embodiments of the invention, may be evaluated using transmission electron microscopy (TEM) or scanning electron microscopy (SEM) imaging.

The particle(s) can be generally shaped as a sphere, incomplete-sphere, particularly the size attached to the substrate, a rod, a cylinder, a ribbon, a sponge, and any other shape, or can be in a form of a cluster of any of these shapes, or can comprises a mixture of one or more shapes.

In some embodiments, the composition comprises the derivatized nano-diamond. In some embodiments, the composition comprises the derivatized nano-tube (e.g. SWNT, or MWNT). In some embodiments, the composition comprises a combination of the derivatized nano-diamond and the derivatized nano-tube. In some embodiments, the derivatized carbon nano-particle is a fluorinated carbon nano-particle. In some embodiments, the derivatized carbon nano-particle is a fluorinated nano-diamond. In some embodiments, the derivatized carbon nano-particle is a fluorinated nano-tube. In some embodiments, the composition comprises a mixture of a fluorinated nano-tube and a fluorinated nano-diamond.

In some embodiments, the derivatized nano-diamond is characterized by a surface water contact angle of more than 40°, more than 50°, more than 60°, more than 70°, more than 80°, more than 90°, more than 100°, including any range or value therebetween. In some embodiments, the derivatized nano-diamond is characterized by a surface water contact angle of more than 105°, 110°, 115°, 120°, 125°, 130°, including any value therebetween.

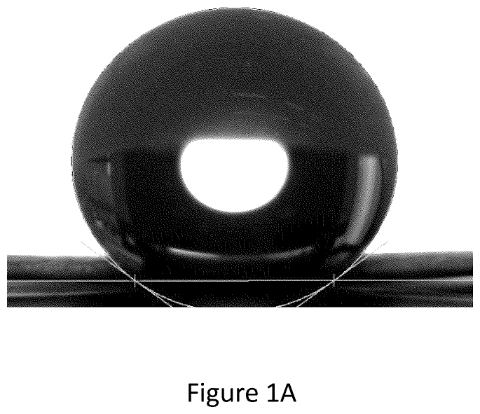

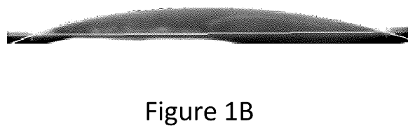

FIG. 1A represents an image of the surface water contact angle of a substrate coated with an exemplary composition of the invention comprising perhydrosilazane and fluorinated nano-diamonds, wherein the contact angle was measured by a tensiometer.

In some embodiments, the derivatized nano-tube is characterized by a surface water contact angle of more than 100°. In some embodiments, the derivatized nano-tube is characterized by a surface water contact angle of more than 105°, 110°, 115°, 120°, 125°, 130°, including any value therebetween.

In some embodiments, the weight per weight (w/w) concentration of the silicon-based polymer within the composition is between 0.1 and 95%. In some embodiments, the weight per weight (w/w) concentration of the silicon-based polymer within the composition is from 0.1 to 0.2%, 0.2 to 0.3%, 0.3 to 0.4%, 0.4 to 0.5%, 0.5 to 0.7%, 0.7 to 1%, 1 to 85%, 5 to 85%, 10 to 85%, 15 to 85%, 20 to 85%, 25 to 85%, 30 to 85%, 1 to 65%, 5 to 65%, 10 to 65%, 15 to 65%, 20 to 65%, 25 to 65%, 30 to 65%, 1 to 55%, 5 to 55%, 10 to 55%, 15 to 55%, 20 to 55%, 25 to 55%, 30 to 55%, 1 to 45%, 5 to 45%, 10 to 45%, 15 to 45%, 20 to 45%, 25 to 45%, 30 to 45%, 1 to 15%, 0.5 to 1%, 1 to 3%, 3 to 5%, 1 to 5%, 5 to 7%, 7 to 8%, 8 to 10%, and 0.5 to 10%, including any range therebetween.

In some embodiments, the concentration of the silicon-based polymer within the composition (e.g. the liquid composition) is between 0.1 and 5% w/w, between 0.1 and 0.3% w/w, between 0.3 and 0.5% w/w, between 0.5 and 1% w/w, between 1 and 2% w/w, between 2 and 3% w/w, between 3 and 4% w/w, between 4 and 5% w/w, between 5 and 7% w/w, between 7 and 10% w/w, between 10 and 15% w/w, between 15 and 20% w/w, including any range therebetween. In some embodiments, the concentration of the silicon-based polymer within the composition of the invention (e.g. the liquid composition) is between 0.5 and 15% w/w, between 0.5 and 20% w/w, including any range therebetween.

Liquid compositions comprising the derivatized carbon nano-particle; and the silicon-based polymer at a concentration between 0.5 and 15% w/w have been successfully prepared and implemented by the inventors, such as for coating of a substrate. Other concentrations of the silicon-based polymer within the composition are currently under study. It is expected, that compositions comprising more than 20%, more than 30%, more than 40%, more than 50%, more than 60%, more than 70%, more than 80%, more than 90% by weight, might be in the form of a semi-liquid composition or a semi-solid composition (e.g. gel).

In some embodiments, the concentration of the silicon-based polymer within the composition (e.g. the liquid composition) is at most 20% w/w, at most 15% w/w, at most 10% w/w, at most 8% w/w, at most 6% w/w, at most 5% w/w, at most 4% w/w, at most 3% w/w, at most 2% w/w, at most 1% w/w, including any range therebetween.

In some embodiments, the derivatized carbon nano-particle is a derivatized carbon nano-tube (e.g. fluorinated SWCNT). In some embodiments, the w/w concentration of the derivatized carbon nano-particle (e.g. derivatized nano-tube) within the composition (e.g. the liquid composition) is from 0.01 to 90%, 0.01 to 90%, 0.05 to 20%, 0.09 to 20%, 0.1 to 20%, 0.5 to 20%, 1 to 20%, 5 to 20%, 10 to 20%, 15 to 20%, 20 to 30%, 30 to 40%, 40 to 50%, 50 to 60%, 60 to 70%, 70 to 80%, 80 to 90%, including any range therebetween. In some embodiments, the composition of the invention comprising at most 50%, at most 40%, at most 30%, at most 20%, at most 10% by weight of the derivatized carbon nano-particle (e.g. derivatized nano-tube) is a liquid or a liquid dispersion. In some embodiments, the composition of the invention comprising more than 80%, more than 70%, more than 60%, more than 50%, more than 50%, more than 40%, more than 30%, more than 20%, at most 10% by weight of the derivatized carbon nano-particle (e.g. derivatized nano-tube) is a semi-liquid or a semi-solid (e.g. gel).

Liquid compositions comprising the silicon-based polymer; and the derivatized carbon nano-tube (e.g. fluorinated SWCNT) have been successfully prepared and implemented by the inventors, such as for coating of a substrate. Other concentrations of the derivatized carbon nano-tubes within the composition are currently under study. It is expected, that compositions comprising more than 20%, more than 30%, more than 40%, more than 50%, more than 60%, more than 70%, more than 80%, more than 90% by weight of the derivatized carbon nano-tube, might be in the form of a semi-liquid composition or a semi-solid composition (e.g. gel). Such compositions comprising more than 20%, more than 30%, more than 40%, more than 50%, more than 60%, more than 70%, more than 80%, more than 90% by weight of the derivatized carbon nano-tube, might be utilized for enhancing elasticity of the coating and/or for obtaining a surface characterized by very high absorbance coefficient with respect to electromagnetic radiation such as light, microwaves, radio waves etc. In some embodiments, a composition comprising more than 20%, more than 30%, more than 40%, more than 50%, more than 60%, more than 70%, more than 80%, more than 90% by weight of the derivatized carbon nano-particle is substantially light impermeable (e.g. has a reduced transparency).

In some embodiments, the derivatized carbon nano-particle is a derivatized carbon nano-diamond (e.g. fluorinated nano-diamond). In some embodiments, the w/w concentration of the derivatized carbon nano-particle (e.g. derivatized carbon nano-diamond) within the composition is 0.01 to 90%, 0.01 to 50%, 0.01 to 0.03%, 0.03 to 0.05%, 0.05 to 0.1%, 0.1 to 0.2%, 0.2 to 0.5%, 0.5 to 1%, 1 to 2%, 2 to 3%, 3 to 5%, 5 to 10%, 10 to 15%, 15 to 20%, 20 to 30%, 30 to 40%, 40 to 50%, 50 to 60%, 60 to 70%, 80 to 90%, including any range therebetween.

In some embodiments, the w/w concentration of the derivatized carbon nano-particle (e.g. derivatized nano-diamond) within the composition (e.g. the liquid composition) is 0.01 to 20%. In some embodiments, the w/w concentration of the derivatized nano-diamond within the composition is 0.01 to 20%, 0.05 to 20%, 0.09 to 20%, 0.1 to 20%, 0.5 to 20%, 1 to 20%, 5 to 20%, 10 to 20%, 15 to 20%, including any range therebetween. In some embodiments, the w/w concentration of the derivatized carbon nano-particle (e.g. derivatized nano-diamond) within the composition (e.g. the liquid composition) is between 0.01 and 7%, between 0.01 and 0.1%, between 0.1 and 0.5%, between 0.5 and 1%, between 1 and 2%, between 2 and 3%, between 3 and 4%, between 4 and 5%, between 5 and 7%, including any range therebetween.

Liquid compositions comprising the silicon-based polymer; and the derivatized nano-diamond (e.g. fluorinated nano-diamond) at a concentration of the nano-diamond between 0.1 and 0.2% w/w have been successfully prepared and implemented by the inventors, such as for coating of a substrate. Other concentrations of the derivatized carbon nano-particles within the composition are currently under study. It is expected, that compositions comprising more than 20%, more than 30%, more than 40%, more than 50%, more than 60%, more than 70%, more than 80%, more than 90% by weight of the derivatized carbon nano-particles, might be in the form of a semi-liquid composition or a semi-solid composition (e.g. gel).

In some embodiments, a w/w ratio of the derivatized carbon nano-particle to the silicon-based polymer within the composition is between 1:10 and 10:1, between 1:1 and 1:2, between 1:2 and 1:3, between 1:3 and 1:5, between 1:5 and 1:7, between 1:7 and 1:10, between 1:1 and 2:1, between 2:1 and 3:1, between 3:1 and 4:1, between 4:1 and 5:1, between 5:1 and 7:1, between 7:1 and 10:1, including any range therebetween.

In some embodiments, a w/w ratio of the derivatized carbon nano-particle to the silicon-based polymer within the composition is between 100:1 and 1:100, between 100:1 and 80:1, between 80:1 and 60:1, between 60:1 and 40:1, between 40:1 and 20:1, between 20:1 and 10:1, between 10:1 and 5:1, between 5:1 and 3:1, between 3:1 and 2:1, between 2:1 and 1:1, between 1:1 and 1:2, between 1:2 and 1:3, between 1:3 and 1:4, between 1:4 and 1:5, between 1:5 and 1:7, between 1:7 and 1:10, between 1:10 and 1:20, between 1:20 and 1:30, between 1:30 and 1:50, between 1:50 and 1:70, between 1:70 and 1:90, between 1:90 and 1:100, including any range or value therebetween. One skilled in the art will appreciate, that an exact ratio between the derivatized carbon nano-particle and the silicon-based polymer will depend on the specific polymer and/or specific particle used within the composition and on the desired properties of the coating. In some embodiments, an increased w/w concentration (e.g. between 0.1 to 0.2%, 0.2 to 0.5%, 0.5 to 1%, 1 to 2%, 2 to 3%, 3 to 5%, 5 to 10%, 10 to 15%, 15 to 20%, 20 to 30%, 30 to 40%, 40 to 50%, 50 to 60%, 60 to 70%, 80 to 90%, including any range therebetween) of the derivatized carbon nano-tube within the composition is preferable for obtaining a flexible coating (e.g. increasing elastic properties of the coating). In some embodiments, an increased w/w concentration (e.g. between 0.1 to 0.2%, 0.2 to 0.5%, 0.5 to 1%, 1 to 2%, 2 to 3%, 3 to 5%, 5 to 10%, 10 to 15%, 15 to 20%, 20 to 30%, 30 to 40%, 40 to 50%, 50 to 60%, 60 to 70%, including any range therebetween) of the derivatized carbon nano-diamond within the composition is preferable for increasing strength and superhydrophobicity of the coating. In some embodiments, an increased w/w concentration of the derivatized carbon nano-diamond decreases elasticity and/or increases brittleness of the coating. In some embodiments, the composition comprising up to 20%, up to 30%, up to 40%, up to 50%, up to 60%, up to 70% of the derivatized carbon nano-particle is a liquid composition.

In some embodiments, the composition comprises the silicon-based polymer and a plurality of derivatized carbon nano-particles, wherein a combined ratio of the plurality of derivatized carbon nano-particles to the silicon-based polymer is between 0.05:1 and 1:1, between 0.05:1 and 0.1:1, between 0.1:1 and 0.2:1, between 0.2:1 and 0.3:1, between 0.3:1 and 0.4:1, between 0.4:1 and 0.5:1, between 0.5:1 and 0.7:1, between 0.7:1 and 1:1, including any range therebetween.

In some embodiments, the composition further comprises a solvent. In some embodiments, the composition further comprises a solvent which is inert to the silicon-based polymer. In some embodiments, a solvent is an organic solvent. In some embodiments, a solvent is selected from an aromatic solvent, and an aliphatic solvent or any combination thereof.

In some embodiments, a solvent comprises a hydrocarbon solvent. In some embodiments, a solvent comprises an aromatic solvent. In some embodiments, a solvent comprises a mixture of solvents. In some embodiments, a solvent comprises a mixture of aromatic solvents and ether. In some embodiments, a solvent comprises kerosene. In some embodiments, a solvent comprises hexane.

In some embodiments, a solvent is dry solvent. As used herein, “dry solvent” refers to non-water, hydrocarbon-based compounds. In some embodiments, a dry solvent comprises only traces of water. In some embodiments, a dry solvent is substantially free of water. In some embodiments, a dry solvent contains no water. In some embodiments, a dry solvent comprises a water content in the solvent is less than about 0.05%. As used herein, “solvent” refers to a compound capable of solubilizing (dissolving, making miscible, etc.) another compound or solute. Exemplary solvents include, but are not limited to hydrocarbons such as alkanes (e.g., hexane, heptane), alkenes and alkynes, aromatic solvents (e.g. toluene, xylene, chlorobenzene, etc.) ethers, esters, ketones, oils, polar or non-polar solvents and silicon fluids (e.g., organosilicon compounds having a hydroxyl group via an organic group bound to the silicon atom). In some embodiments, a solvent is substantially devoid of a protic solvent.

In some embodiments, a solvent according to the present invention is a solvent that can be easily evaporated.

In some embodiments, non-dry solvents are suitable to the invention (e.g. if the silicon-based polymer is stable or non-reactive with water). In some embodiments, the solvent comprises, without being limited thereto, ethanol, isopropanol, methanol, butanol, pentanol, water or any mixture or combination thereof (e.g. if the silicon-based polymer is stable or non-reactive with the abovementioned solvents).

In some embodiments, the composition is devoid of an additional polymer. As used herein throughout, the term “polymer” describes an organic substance composed of a plurality of repeating structural units (backbone units) covalently connected to one another.

In some embodiments, a polymer is a silicon-based polymer. In some embodiments, a polymer is a silane-based polymer. In some embodiments, a polymer is an inorganic polymer.

In some embodiments, the composition comprises a fluorinated nano-diamond, a perhydropolysilazane based polymer, and a solvent. In some embodiments, the composition comprises a fluorinated carbon nano-tube, a perhydropolysilazane based polymer, and a solvent. In some embodiments, the composition comprises a fluorinated nano-diamond and/or a fluorinated carbon nano-tube, a perhydropolysilazane based polymer, and a solvent.

In some embodiments, the composition is devoid of an additional particle. In some embodiments, the composition is devoid of a binder. In some embodiments, the composition is devoid of an additional carbon particle (e.g. nano-diamond, and/or CNT). In some embodiments, the derivatized carbon nano-particle is substantially devoid of a polymer. In some embodiments, the derivatized carbon nano-particle of the invention consists essentially of the derivatized carbon nano-particles listed herein. In some embodiments, the derivatized carbon nano-particle is substantially composed of a single specie (e.g. derivatized nano-diamonds or derivatized CNTs). In some embodiments, the derivatized carbon nano-particles are substantially identical.

In some embodiments, a composition according to the present invention, is stable to climatic changes. In some embodiments, the composition is stable to temperature changes, heat, cold, UV radiation and atmospheric corrosive elements. In some embodiments, the characteristics of the composition are not affected or altered by climatic changes as described herein. In some embodiments, a polymer according to the present invention, is stable to climatic changes. In some embodiments, the polymer is stable to temperature changes, heat, cold, UV radiation and atmospheric corrosive elements. In some embodiments, the structure of the polymer is not affected or altered by climatic changes as described herein.

In some embodiments, the composition is a liquid or a liquid composition. In some embodiments, the liquid composition is applied on the substrate by a method selected from dipping, spraying, spreading, brushing, painting, rolling etc. A person skilled in the art will appreciate, that there are various well-known methods for applying a liquid composition or a liquid dispersion on a substrate. Additionally, a person skilled in the art will appreciate, that applying a liquid composition or a liquid dispersion can be easily applied on the substrate without using any sophisticated coating teachings such as thermal curing, UV-curing, firing (e.g. exposing to high temperatures, such as to a temperature between 10° and 1500° C. including any range between), vapor phase deposition, chemical vapor deposition, physical vapor deposition, or any combination thereof.

In some embodiments, the composition is a solid. In some embodiments, the composition is a solid powder. In some embodiments, the composition is a semi-solid or a semi-liquid. In some embodiments, the composition of the invention is in a form of a gel. In some embodiments, the composition of the invention is substantially homogenous. In some embodiments, the composition of the invention is substantially stable, wherein stable is refers to the ability of the composition maintain its structural and/or functional properties (such as a mechanical property, surface property, etc.).

It should be understood that the term “semi-liquid” or “semi-solid”, is intended to mean materials which are flowable under pressure and/or shear force. In some embodiments, semi-liquid compositions include creams, ointments, gel-like materials and other similar materials. In some embodiments, the composition is a semi-liquid composition, characterized by a viscosity in a range from 31,000-800,000 cps.

In some embodiments, the composition is a dispersion. In some embodiments, the composition (e.g. the dispersion) is substantially homogenous. In some embodiments, the composition is a dispersion comprising a plurality of derivatized carbon nano-particles dispersed therewith. In some embodiments, the polymer of the invention stabilizes the composition (e.g. liquid composition and/or dispersion). In some embodiments, the plurality of derivatized carbon nano-particles are homogenously dispersed within the composition.

In some embodiments, the composition is a solid, and a w/w ratio between the total content of the derivatized carbon nano-particles (e.g. derivatized nano-diamond and/or the derivatized CNT) to the silicon-based polymer (e.g. polysilazane) is between 100:1 and 1:100, between 100:1 and 80:1, between 80:1 and 60:1, between 60:1 and 40:1, between 40:1 and 20:1, between 20:1 and 10:1, between 10:1 and 5:1, between 5:1 and 3:1, between 3:1 and 2:1, between 2:1 and 1:1, between 1:1 and 1:2, between 1:2 and 1:3, between 1:3 and 1:4, between 1:4 and 1:5, between 1:5 and 1:7, between 1:7 and 1:10, between 1:10 and 1:20, between 1:20 and 1:30, between 1:30 and 1:50, between 1:50 and 1:70, between 1:70 and 1:90, between 1:90 and 1:100, including any range or value therebetween. In some embodiments, the composition is a solid, and a w/w ratio between the total content of the derivatized carbon nano-particles (e.g. derivatized nano-diamond and/or the derivatized CNT) to the silicon-based polymer (e.g. polysilazane) is between 2:1 and 1:1, between 1:1 and 1:2, between 1:2 and 1:3, between 1:3 and 1:4, between 1:4 and 1:5, between 1:5 and 1:7, between 1:7 and 1:10, between 1:10 and 1:20, between 1:20 and 1:30, between 1:30 and 1:50, between 1:50 and 1:70, between 1:70 and 1:90, between 1:90 and 1:100, including any range or value therebetween.

In some embodiments, the composition is a liquid composition comprising the derivatized carbon nano-particle (e.g. the fluorinated nano-diamond or the fluorinated CNT), a polysilazane (e.g. perhydropolysilazane), and the solvent. In some embodiments, the composition or the liquid composition is stable. In some embodiments, the composition or the liquid composition is stable for a time period between 30 and 1000 days (d), between 30 and 1000 d, between 30 and 1000 d, between 30 and 1000 d, between 30 and 60 d, between 60 and 100 d, between 100 and 200 d, between 200 and 300 d, between 300 and 400 d, between 400 and 500 d, between 500 and 600 d, between 600 and 700 d, between 700 and 800 d, between 800 and 1000 d, including any range or value therebetween.

As used herein the term “stable”, refers to the ability of the liquid composition to maintain substantially its intactness, such as being substantially devoid of aggregation, precipitation and/or phase separation. In some embodiments, a stable composition (e.g. the composition or the liquid composition of the invention) is substantially devoid of aggregates. In some embodiments, aggregates comprising a plurality of particles (e.g. derivatized carbon nano-particles) adhered or bound to each other.

Typical aggregates may have a particle size ranging from hundreds of nanometers to several micrometers. In some embodiments, the polymer of the invention substantially prevents aggregation of the derivatized carbon nano-particles. In some embodiments, the polymer of the invention substantially enhances or provides stability to the composition of the invention (e.g. the liquid composition).

In some embodiments, the polymer of the invention forms a matrix, wherein the derivatized carbon nano-particles are in contact with or bound thereto. In some embodiments, bound is via a non-covalent bond. In some embodiments, the derivatized carbon nano-particles are embedded within the matrix. In some embodiments, the derivatized carbon nano-particles are encapsulated by the matrix. In some embodiments, the derivatized carbon nano-particle provides reinforcement to the resulting coating formed upon applying the composition on the substrate.

In some embodiments, the composition comprises an additive. In some embodiments, a w/w concentration of the additive within the composition is between 0.1 and 10%, between 0.1 and 0.5%, between 0.5 and 1%, between 1 and 2%, between 2 and 5%, between 5 and 10%, including any range therebetween. In some embodiments, the additive is selected from the group consisting of metals or metal salts (e.g. conductive metal nano-particles), dielectric materials (e.g. metal oxides), anti-microbial and anti-fouling agents or any combination thereof.

In some embodiments, the additive is selected from the group consisting of a luminophore, a colorant, a dye, a pigment, a photosensitizer, and a fluorophore or any combination thereof. In some embodiments, the additive is a luminophore. In some embodiments, the luminophore comprises any one of an organic luminophore, an inorganic luminophore, and a quantum dot luminophore or any combination thereof.

Non-limiting examples of quantum dot luminophores include but are not limited to: silicate phosphor, aluminate phosphor, phosphate phosphor, sulfide phosphor, nitride phosphor, nitrogen oxide phosphor, or any combination thereof. In some embodiments, the quantum dot luminophore is in a form of particles (e.g. nano-particles). Other quantum dot luminophores are well-known in the art, such as materials disclosed in U.S. Pat. No. 9,234,129 and in U.S. Pat. No. 10,611,957.

In some embodiments, the additive (e.g. the luminophore) acts as an indicator for any one of coating thickness, and coating stability.

In some embodiments, the composition (e.g. the liquid composition) is substantially colorless. In some embodiments, the composition (e.g. the liquid composition) is substantially transparent.

In some embodiments, the composition comprises an adhesiveness or binding property to a surface. In some embodiments, the silicon-based polymer comprises an adhesiveness property to a surface. In some embodiments, the adhesiveness property comprises a covalent or a non-covalent bond formation. In some embodiments, the derivatized carbon nano-particle enhances adhesiveness of the silicon-based polymer. In some embodiments, a composition according to the present invention provides sufficient binding or adhesiveness to a surface. Without being bound by any particular theory or mechanism, it is assumed that the silicon-based polymer provides a sufficient binding to a surface. In some embodiments, binding is via a covalent bond. In some embodiments, binding is via a physical bond. In some embodiments, binding is via hydrophobic interactions. In some embodiments, binding is a stable and non-migrated bonding. In some embodiments, non-migrated bonding refers to the fact that the composition is bound to the substrate surface and not able to move through the surface.

In some embodiments, the derivatized carbon nano-particle enhances mechanical strength of the coating. In some embodiments, the derivatized carbon nano-particle reinforces the coating. In some embodiments, the derivatized carbon nano-particle enhances stability of the coating.

In some embodiments, binding is obtained without using a curing agent. As used herein, the term “curing agent” refers to a substance typically added to a surface to facilitate the bonding of molecular components to the surface.

In some embodiments, the composition comprising the silicon-based polymer and the derivatized carbon nano-particle has an improved stability as compared to non-derivatized carbon nano-particle. In some embodiments, the composition comprising the derivatized silicon-based polymer and the derivatized carbon nano-particle has an improved stability. In some embodiments, the composition comprising fluorinated perhydropolysilazane and a fluorinated carbon nano-particle has an improved stability. In some embodiments, the composition comprising the silicon-based polymer and the fluorinated carbon nano-particle has an improved stability in a solvent. In some embodiments, a dispersion comprising the silicon-based polymer and the fluorinated carbon nano-particle has an improved stability.

In some embodiments, the composition of the invention is for use as a coating. In some embodiments, the composition is a coating composition. In some embodiments, the composition is for use in the formation of a coating (e.g. on top of a substrate). In some embodiments, the composition or the coating composition is for coating a surface of a substrate.

In some embodiments, the composition is a solid composition. In some embodiments, the composition (e.g. solid composition) is in a form of a film. In some embodiments, the composition (e.g. solid composition) is in a form of a fiber. In some embodiments, the composition (e.g. solid composition) is in a form of a sheet.

A “fiber” as used herein, is meant a fine cord of fibrous material composed of two or more filaments twisted together. By “filament” is meant a slender, elongated, threadlike object or structure of indefinite length, ranging from microscopic length to lengths of a mile or greater.

In some embodiments, there is provided a composition for use as an anti-fouling coating, an anti-corrosion coating, a UV-protective coating, a heat resistant coating, a chemical resistant coating, a superhydrophobic coating, an oleophobic coating, a lyophobic coating, an anti-abrasive coating, a self-cleaning coating, anti-fogging coating, anti-scratch coating, or any combination thereof.

The term “lyophobic” is referred to a surface of the substrate, providing a combination of hydrophobic and oleophobic properties

The term “anti-fouling”, “anti-biofouling” or “anti-biofouling activity” is referred to as an ability to inhibit (prevent), reduce or retard growth of organisms and biofilm formation on a substrate's surface.

In some embodiments, the present invention provides a composition for use as an anti-fogging coating. In some embodiments, the coating is characterized by anti-fogging properties. The term “anti-fog”, “anti-fogging” and the like are used herein to indicate a composition or a compound that is capable of providing antifogging properties on at least one portion thereof. In the context of the disclosed coating composition deposited on or incorporated within a substrate, this term is meant to refer to the antifogging properties being imparted on at least one surface of the substrate.

Antifogging properties may be characterized by e.g., roughness, water contact angle, haze and gloss or by a combination thereof. The term “roughness” as used herein relates to the irregularities in the surface texture. Irregularities are the peaks and valleys of a surface.

By “antifogging properties” it is meant to refer, inter alia, to the capability of a substrate's surface to prevent water vapor from condensing onto its surface in the form of small water drops redistributing them in the form of a continuous film of water in a very thin layer.

According to some embodiments, the present invention provides a composition for use as an abrasion resistant coating. In some embodiments, the present invention provides a coating with improved abrasion resistance. As used herein, the term “abrasion resistance” refers to the ability of a material to stop the displacement when exposed to a relative movement of the hard particles or projections. Displacement is visually observed to be typically the bottom surface exposed by the removal of the coating material. Abrasion resistance can be measured through a variety of tests known in the art, such as for example, burned off (Taber) wear test, Gardner scrubber (Gardner scrubber) test, a sand-fall (falling sand) tests.

According to some embodiments, the present invention provides a scratch resistant coating.

The term “hydrophobic coating” is one that results in a water droplet forming a surface water contact angle exceeding about 90° and less than about 150° at room temperature (about 18 to about 23° C.).

The term “superhydrophobic coating” is defined as surfaces which have a water contact angle above 140° but less than the theoretical maximum contact angle of about 180° at room temperature. In nature, lotus leaves are considered super hydrophobic. Water drops roll off the leaves collecting dirt along the way to give a “self-cleaning” surface.

In some embodiments of the invention, a composition, an article and/or a coated substrate disclosed herein exhibit a water contact angle on the surface of at least 130°, 140°, 150°, 160°, 165° with an aqueous liquid, or any value therebetween.

In some embodiments, the composition, articles or coated substrates disclosed herein exhibit a water contact angle on the surface in a range from 40° to 90°, from 90° to 160°, from 90° to 150°, from 90° to 140°, from 90° to 130°, from 90° to 120°, or any range therebetween.

In some embodiments, the composition comprising perhydrosilazane, and a derivatized carbon nano-particle comprising a fluorinated nano-diamond, a fluorinated SWCNT or both is characterized a water contact angle on the surface in a range from 90° to 160°, from 90° to 150°, from 90° to 140°, from 90° to 130°, from 90° to 120°, or any range therebetween. In some embodiments, the composition comprising perhydrosilazane, and a derivatized carbon nano-particle comprising a fluorinated nano-diamond, a fluorinated SWCNT or both is characterized a water contact angle on the surface of greater than 40°, greater than 60°, greater than 80°, greater than 100°, greater than 120°, greater than 130°, greater than 140°, including any range or value therebetween.

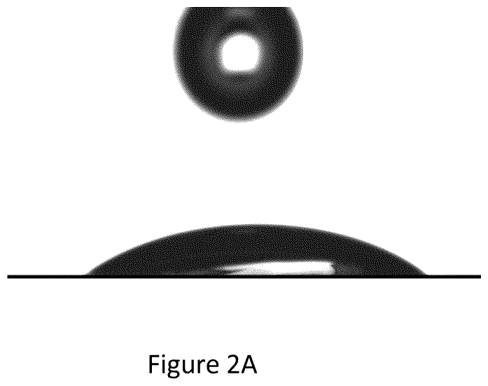

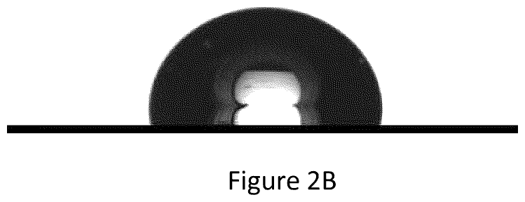

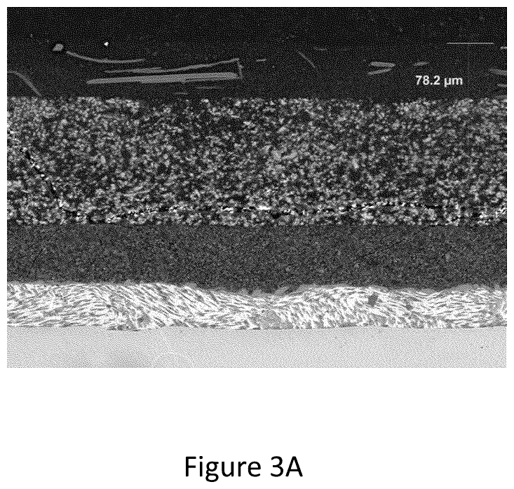

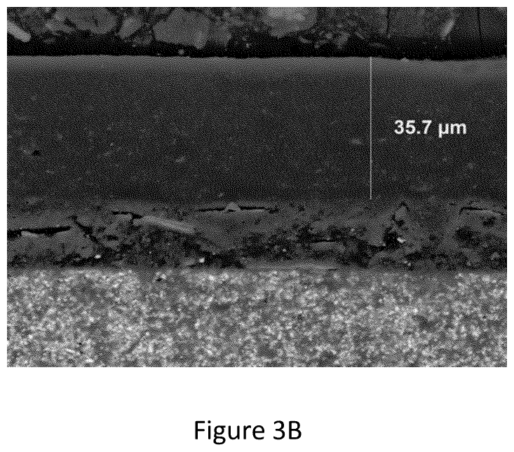

FIG. 2B represents a surface water contact angle of a substrate coated with a control composition composed of perhydrosilazane and non-modified nano-diamonds (showing a contact angle of about 16 degrees).

As used herein the term “coating” and any grammatical derivative thereof, is defined as a coating that (i) is positioned above a substrate, (ii-a) it is in contact with the substrate, or (ii-b) is not necessarily in contact with the substrate, that is to say one or more intermediate coatings may be arranged between the substrate and the coating in question, and (iii) does not necessarily completely cover the substrate.

In some embodiments, the coating can be applied as single coating layer or as a plurality of coating layers.

According to another aspect of the invention, there is a kit comprising a first compartment comprising the silicon-based polymer of the invention, and a second compartment comprising the derivatized carbon nano-particle of the invention. In some embodiments, the kit further comprises a third compartment comprising the solvent. In some embodiments, the compartments are mixed together so as to result the composition (e.g. the liquid composition) of the invention. In some embodiments, the compartments are mixed together prior to the application (e.g. on a substrate).

In one embodiment, a “combined preparation” defines especially a “kit of parts” in the sense that the combination partners as described herein can be dosed independently or by use of different fixed combinations with distinguished amounts of the combination partners i.e., simultaneously, concurrently, separately or sequentially. In some embodiments, the parts of the kit of parts can then, e.g., be used simultaneously or chronologically staggered, that is at different time points and with equal or different time intervals for any part of the kit of parts. The ratio of the total amounts of the combination partners, in some embodiments, can be used in the combined preparation.

In some embodiments, the kit comprises instructions for mixing together any the compartments of the kit so as to obtain the composition of the invention. In some embodiments, compartments of the kit are mixed together up to 48 h, up to 24 h, up to 12 h, up to 5 h, up to 3 h, up to 1 h, before use of the resulting composition of the invention. In some embodiments, the compartments of the kit are mixed together for at least 10 second before use. In some embodiments, mixing is as described hereinbelow.

### Coated Substrates

According to an aspect of some embodiments of the present invention there is provided a coated substrate, comprising a substrate, a silicon-based polymer, and a derivatized carbon nano-particle. In some embodiments, the silicon-based polymer is bound to at least a portion of the substrate. In some embodiments, the derivatized carbon nano-particle is in contact with the silicon-based polymer. In some embodiments, the derivatized carbon nano-particle and the silicon-based polymer are forming a coating layer. In some embodiments, the derivatized carbon nano-particle and the silicon-based polymer are as described elsewhere herein. In some embodiments, the silicon-based polymer is silicon carbide.

In some embodiments a coating layer as described in any of the respective embodiments is incorporated in and/or on at least a portion of the substrate. In some embodiments a coating layer as described in any of the respective embodiments is incorporated in and/or on at least a portion of at least one surface of the substrate.

According to an aspect of some embodiments of the present invention, there is provided a substrate having incorporated in and/or on at least a portion thereof the disclosed coating layer as described herein.

By “a portion thereof” it is meant, for example, a surface or a portion thereof, and/or a body or a portion thereof, of solid or semi-solid substrates; or a volume or a part thereof, of liquid, gel, foams and other non-solid substrates.

Without being bound by any particular theory or mechanism, it is assumed that the silicon-based polymer provides an adhesiveness property to the substrate, and the derivatized carbon nano-particle provides additional physical properties to the final coating (e.g. mechanical strength, hydrophobicity, oleophobicity, etc.). The silicon-based polymer may form a matrix which binds the derivatized carbon nano-particle. The binding may be via non-covalent interactions, such as Van-der Waals bonding, or 71-71 stacking. Additionally, surface modification of carbon nano-particles (e.g. fluorination) results in improved bonding of the derivatized nanoparticle with the polymeric matrix, as compared to non-derivatized carbon nano-particles. By “adhesiveness property” it is meant, a covalent or a non-covalent binding of the polymer to the surface or a portion thereof. For example, it is known in the art, that polysilazanes are able to attach to a surface via a covalent bond formation with surface-bound hydroxyl groups.

In some embodiments, the coating layer is characterized by a surface contact angle of more than 90°. In some embodiments, the coating layer is characterized by a surface contact angle of more than 100°, 105°, 110°, 115°, 120°, 125°, 130°, including any value therebetween. In some embodiments, the coating layer is characterized by a water contact angle of at least 130°. In some embodiments, the coating layer is characterized by a water contact angle in the range of 40 to 50°, 50 to 60°, 60 to 70°, 70 to 90°, 90 to 100°, 100° to 180°, 120° to 180°, 130° to 180°, 130° to 168°, 130° to 165°, 130° to 160°, 130° to 150°, or 135° to 165°, including any range therebetween. In some embodiments, the coated substrate is characterized by a surface contact angle of more than 90°. In some embodiments, the coated substrate is characterized by a surface contact angle of more than 100°, 105°, 110°, 115°, 120°, 125°, 130°, including any value therebetween. In some embodiments, the coated substrate is characterized by a water contact angle of at least 130°. In some embodiments, the coating layer is characterized by a water contact angle in the range of 100° to 180°, 110° to 180°, 120° to 180°, 130° to 180°, 130° to 168°, 130° to 165°, 1300 to 160°, 1300 to 150°, or 1350 to 165°, including any range therebetween.

In some embodiments, the coating layer is stable at a temperature in the range of −100 to 1500° C., −100 to 1500° C., −80 to 1500° C., −70 to 1500° C., −50 to 1500° C., −20 to 1500° C., −10 to 1500° C., −5 to 1500° C., 0 to 1500° C., −100 to 1500° C., −100 to 1000° C., −80 to 1000° C., −70 to 1000° C., −50 to 1000° C., −20 to 1000° C., −10 to 1000° C., −5 to 1000° C., 0 to 1000° C., −100 to 800° C., −100 to 800° C., −80 to 800° C., −70 to 800° C., −50 to 800° C., −20 to 800° C., −10 to 800° C., −5 to 800° C., 0 to 800° C., −100 to 1500° C., −100 to 1500° C., −80 to 1500° C., −70 to 1500° C., −50 to 1500° C., −20 to 1500° C., −10 to 1500° C., −5 to 1500° C., 0 to 1500° C., −100 to 1500° C., −100 to 1500° C., −80 to 500° C., −70 to 500° C., −50 to 500° C., −20 to 500° C., −10 to 500° C., −5 to 500° C., 0 to 500° C., −100 to 100° C., −100 to 100° C., −80 to 100° C., −70 to 100° C., −50 to 100° C., −20 to 100° C., −10 to 100° C., −5 to 50° C., 0 to 50° C., of −100 to 50° C., −100 to 50° C., −80 to 50° C., −70 to 50° C., −50 to 50° C., −20 to 50° C., −10 to 50° C., −5 to 50° C., or 0 to 50° C., including any range therebetween.

As used herein the term “stable” refers to the ability of the coating layer to substantially maintain its structural, physical and/or chemical properties. In some embodiments, the coating layer is referred to as stable, when it substantially maintains its structure (e.g. shape, and/or a dimension such as thickness, length, etc.), wherein substantially is as described herein. In some embodiments, the term “stable” as used herein, comprises maintaining any one of the properties such as hydrophobicity, weather protection, gas barrier, corrosion protection, wear protection, extending the life of the substrate, etc.

In some embodiments, the coating layer is referred to as stable, when it is substantially devoid of cracks, deformations or any other surface irregularities.

In some embodiments, the coating layer is characterized by a pencil hardness of at least 4H, at least 5H, at least 7H, at least 8H, at least 9H, including any value therebetween. In some embodiments, the coating layer is characterized by a pencil hardness in the range of 4H to 10H, including any range therebetween. As used herein the term “pencil hardness” refers to a hardness measured by means of a pencil scratch tester for coating films.

In some embodiments, the coating layer is characterized by a hardness of between 0.1 GPa and 20 GPa, between 0.1 GPa and 4.5 GPa, between 0.1 GPa and 5 GPa, between 0.1 GPa and 1 GPa, between 1 GPa and 3 GPa, between 3 GPa and 5 GPa, between 5 GPa and 10 GPa, between 10 GPa and 15 GPa, between 15 GPa and 20 GPa including any range therebetween, wherein hardness is measured by nanoindentation according to ISO 14577 test.

In some embodiments, the coating is characterized by an increased hardness compared to a control (e.g. a corresponding coating with the same thickness being devoid of the derivatized carbon nano-particle). In some embodiments, the hardness of the coating is increased by at least 10%, at least 20%, at least 30%, at least 40%, at least 50%, at least 60%, at least 80%, at least 100%, at least 150%, at least 200%, at least 250%, at least 300%, at least 350%, at least 4000%, including any range therebetween compared to a control. Experimental results summarizing mechanical properties of the exemplary coatings of the invention are represented in the Examples section.

In some embodiments, the coating layer transmits at least 50% of visible light. In some embodiments, the coating layer transmits at least 60%, at least 70%, at least 80%, at least 90%, or at least 95%, of visible light, including any value therebetween. In some embodiments, the coating layer transmits 50% to 100%, 50% to 98%, 50% to 95%, 50% to 90%, 50% to 85%, 50% to 80%, 50% to 75%, 50% to 70%, 60% to 100%, 60% to 98%, 60% to 95%, 60% to 90%, 60% to 85%, 60% to 80%, 60% to 75%, or 60% to 70%, of visible light, including any range therebetween.

In some embodiments, the coating layer is substantially light impermeable. In some embodiments, substantially light impermeable coating or coating layer is formed by applying a composition of the invention on the substrate, wherein the comprises at least 40%, at least 50%, at least 60%, at least 80%, at least 90%, at least 95%, at least 99% by weight of one or more derivatized carbon nano-particle (e.g. derivatized SWCNT).

In some embodiments, when applied on the substrate, the coating layer does not alter the external appearance of the substrate. In some embodiments, the coating layer is transparent. In some embodiments, the coating layer is a solid. In some embodiments, the terms “coating layer” and “coating” are used herein interchangeably.

In some embodiments, the substrate is at least partially hydrophobic substrate. In some embodiments, the substrate is a hydrophobic substrate. In some embodiments, the substrate is at least partially hydrophilic. In some embodiments, the substrate is a hydrophilic substrate. In some embodiments, the substrate is at least partially oxidized.

Substrate usable according to some embodiments of the present invention can have, for example, organic or inorganic surfaces, including, but not limited to, glass surfaces; porcelain surfaces; ceramic surfaces; silicon or organosilicon surfaces, metallic surfaces (e.g., stainless steel); polymeric surfaces such as, for example, plastic surfaces, rubbery surfaces, paper; wood; fabric in a woven, knitted or non-woven form; mineral (rock or glass), surfaces, wool, silk, cotton, hemp, leather, fur, feather, skin, hide, pelt or pelage surfaces, plastic surfaces and surfaces comprising or made of polymers, nylons, inorganic polymers such as silicon rubber or glass; or can comprise or be made of any of the foregoing substances, or any mixture thereof. The substrate may be any number of substrates, porous, and non-porous substrates. By non-porous it is meant that a substrate does not have pores sufficient to significantly increase the bonding of the coating to the unprimed substrate. Non-porous substrates are selected from but are not limited to polymers of polycarbonate, polyesters, nylons, and metallic foils such as aluminum foil, with nylons and metallic foils.

In some embodiments, the substrate comprises a glass substrate. Non-limiting examples of glass substrates according to the present invention comprise: borosilicate-based glass substrate, silicon-based glass substrate, ceramic-based glass substrate, silica/quartz-based glass substrate, aluminosilicate-based glass substrate, or any combination thereof.

In some embodiments, the substrate comprises a polymeric substrate. In some embodiments, a polymeric substrate comprises a polymer selected from the group consisting of: polypropylene (PP), polycarbonate (PC), high-density polyethylene (HDPE), low-density polyethylene (LDPE), very low-density polyethylene (VLDPE), polyester, polyethylene terephthalate (PET), polycarbonate (PC), polyvinyl chloride (PVC), polymethyl methacrylate (PMMA), silicon, silicon rubber, polyacetal, cellulose, cellulose derivatives, poly(2-hydroxyethyl methacrylate) (pHEMA), nylon, and any combination thereof.

In some embodiments, the substrate is a metal substrate. In some embodiments, the metal substrate is further coated with a paint and/or lacquer.

Substrate usable according to some embodiments of the present invention can therefore be hard (rigid) or soft, solid, semi-solid, or liquid substrates, and may take a form of a foam, a solution, an emulsion, a lotion, a gel, a cream or any mixture thereof.

Substrates of widely different chemical nature can be successfully utilized for incorporating the disclosed composition and coating layers, as described herein. By “successfully utilized” it is meant that (i) the disclosed composition and coating layers, successfully form a uniform and homogenously coating on the substrate's surface; and (ii) the resulting coating imparts long-lasting desired properties to the substrate's surface. In some embodiments, the substrate is further coated with a lacquer, a varnish or a paint.

In some embodiments, the disclosed composition and coating layer form a layer thereof in/on a surface the substrate. In some embodiments, the coating layer represent a surface coverage referred to as “layer” e.g., 100%. In some embodiments, the coating layer represents about 90%, about 80%, about 70%, about 60%, about 50%, about 40%, of surface coverage, including any value therebetween. In some embodiments, the substrate further comprises a plurality of coating layers.

As used herein, the term “coat” refers to the combined layers disposed over the substrate, excluding the substrate, while the term “substrate” refers to the part of the composite structure supporting the disposed layer/coating. In some embodiments, the terms “layer”, refers to a substantially uniform-thickness of a substantially homogeneous substance.

In some embodiments, the coating layer is homogenized deposited on a surface.

In some embodiments, the coating layer is characterized by an average thickness of 1 μm to 400 μm. In some embodiments, the dry layer thickness is up to about 400 microns, however thicker or thinner layers can be achieved. In some embodiments, the coating layer is characterized by an average thickness of 1 μm to 350 μm, 1 μm to 300 μm, 1 μm to 200 μm, 1 μm to 150 μm, 1 μm to 100 μm, 1 μm to 80 μm, 1 μm to 700 μm, 1 μm to 50 μm, 1 μm to 20 μm, 1 μm to 10 μm, 10 μm to 15 μm, 15 μm to 20 μm, 20 μm to 30 μm, 1 μm to 5 μm, 5 μm to 350 μm, 5 μm to 300 μm, 5 μm to 200 μm, 5 μm to 150 μm, 5 μm to 100 μm, 5 μm to 80 μm, 5 μm to 700 μm, 5 μm to 50 μm, 5 μm to 20 μm, 10 μm to 350 μm, 10 μm to 300 μm, 10 μm to 200 μm, 10 μm to 150 μm, 10 μm to 100 μm, 10 μm to 80 μm, 10 μm to 700 μm, 10 μm to 50 μm, or 10 μm to 20 μm, including any range therebetween.

In some embodiments, the dry layer is characterized by an average thickness of 1 μm to 350 μm, 1 μm to 300 μm, 1 μm to 200 μm, 1 μm to 150 μm, 1 μm to 100 μm, 1 μm to 80 μm, 1 μm to 700 μm, 1 μm to 50 μm, 1 μm to 20 μm, 1 μm to 10 μm, 1 μm to 5 μm, 5 μm to 350 μm, 5 μm to 300 μm, 5 μm to 200 μm, 5 μm to 150 μm, 5 μm to 100 μm, 5 μm to 80 μm, 5 μm to 700 μm, 5 μm to 50 μm, 5 μm to 20 μm, 10 μm to 350 μm, 10 μm to 300 μm, 10 μm to 200 μm, 10 μm to 150 μm, 10 μm to 100 μm, 10 μm to 80 μm, 10 μm to 700 μm, 10 μm to 50 μm, or 10 μm to 20 μm, including any range therebetween.

In some embodiments, the term “dry layer thickness” as used herein refers to the layer thickness obtained by storing the substrate at room conditions (e.g., at 25° C. and humidity of up to e.g., 60% and measuring the thickness thereof under that condition).

In some embodiments, deposition of the coating layer comprising the composition of the invention on variable substrates resulted in imparting advantageous properties to the substrate's surface such as superhydrophobicity, and hardness. In some embodiments, the coating layer comprises a plurality of layers. In some embodiments, the coating layer comprises between 1 and 10, between 1 and 3, between 3 and 5, between 5 and 7, between 1 and 10 layers, including any range therebetween. In some embodiments, the coating layer (e.g. a coating comprising a plurality of layers) remains its stability and/or elasticity. In some embodiments, the coating layer remains its stability and/or elasticity at a thickness of at most 10 μm, at most 20 μm, at most 30 μm, at most 40 μm, including any range therebetween. The inventors successfully utilized a coating comprising perhydrosilazane (1-5% w/w) and a combination of fluorinated SWCNT and of fluorinated nano-diamonds (0.2-1% combined weight ratio). The resulted coating (data not shown) was stable and flexible (e.g. bendable and/or foldable) even at a coating thickness of up to 20 μm.

Based on experimental results obtained by the inventors (data not shown), the composition of the invention is characterized by an increased number of coating layers, which can be applied on a substrate surface, compared to a coating based on polysilazane (e.g. perhydrosilazane). Thus, the composition of the invention facilitates to increase the number of layers which can be applied to a surface, thus increasing thickness of the resulting coating, compared to a control. In some embodiments, the control is a polysilazane-based coating (e.g. having the same polymer concentration), being devoid of derivatized carbon nano-particles. In an exemplary configuration, the inventors obtained a coating thickness of between 10 and 20 μm by utilizing the composition of the invention, compared to a coating thickness of between 1 and 2 μm obtained by applying a perhydrosilazane based coating (e.g. 10 times increase of the coating thickness). In some embodiments, the coating comprising the composition of the invention is substantially devoid of cracks, scratches and/or other structural defects.

In some embodiments, the coating or the coating layer is characterized by a thickness being greater, then a thickness of a control layer. In some embodiments, the control layer is a polysilazane-based coating having the same polymer concentration, without derivatized carbon nano-particles. In some embodiments, the coating comprises more layers, compared to a control. In some embodiments, the composition of the invention enables to increase a number of layers within the coating, compared to a control. In some embodiments, the composition of the invention is capable of forming a multi-layer coating having greater number of layers compared to a control. In some embodiments, a number of layers within the coating of the invention is increased by at least 10%, at least 20%, at least 50%, at least 70%, at least 100%, at least 200%, at least 300%, at least 400%, at least 500%, at least 600%, at least 700%, at least 800%, at least 1000%, including any range therebetween compared to a control.

In some embodiments, the coating is stable (e.g. devoid of cracks). In some embodiments, the coating has an improved stability, compared to a control. In some embodiments, the coating has an improved durability, compared to a control.

In some embodiments, the coating is characterized by an enhanced Young's modulus, compared to a control (e.g. a corresponding coating layer without derivatized carbon nano-particles). In some embodiments, the Young's modulus of the coating is enhanced by at least 50%, at least 100%, at least 200%, at least 300%, at least 400%, at least 500%, at least 600%, at least 700%, at least 1000%, compared to a control including any range or value therebetween. Experimental results summarizing mechanical properties of the exemplary coatings of the invention are represented in the Examples section.

In some embodiments, the coating is characterized by an enhanced Young's modulus, compared to a corresponding coating layer with non-derivatized carbon nano-particles.

In some embodiments, a coating layer comprising derivatized carbon nano-particles and a silicon-based polymer as described herein, has an increased hardness compared to a corresponding coating layer without derivatized carbon nano-particles. In some embodiments, the coating comprising the composition of the invention facilitates or improves absorption of electromagnetic radiation. In some embodiments, the coating or facilitates or improves attenuation of electromagnetic radiation. In some embodiments, the electromagnetic radiation comprises any one of UV-light, visible light, IR-light, radio waves etc., including any combination thereof.

### The Method

According to an aspect of some embodiments of the present invention there is provided a process of coating substrates with the composition or coating layer as described herein. In some embodiments, there is provided a method of coating a substrate, comprising the steps of providing a substrate, and contacting the substrate with the composition as described herein, thereby forming a coating layer on the substrate.

In some embodiments, the composition described herein above is manufactured by mixing the silicon-based polymer, the derivatized carbon nanoparticle, and optionally a solvent. In some embodiments, mixing is performed via extrusion, high shear mixing, three-roll mixing, rotational mixing, or solution mixing. In some embodiments, the formation of these coated substrates does not require the presence of a film former, surfactant or stabilizer. In some embodiments, the process does not require the presence of a curing agent.

In some embodiments, contacting is selected from the group comprising: dipping, spraying, spreading, or curing. In some embodiments, the coating can be easily applied in the substrate with the use of a brush, roller, spray, or dipping. In some embodiments, the coating is applied to the substrate by a method selected from the group comprising: spin coating, spray coating, spray and spin coating, curtain coating, flow coating, dip coating, injection molding, casting, roll coating, wire coating, thermal spraying, high velocity oxygen fuel coating, centrifugation coating, spin coating, vapor phase deposition, chemical vapor deposition, physical vapor deposition and any of the methods used in preparing coating layers.

Generally, the application method selected will depend upon, among other things, chemical properties of materials composing the coating, the thickness of the desired coating, the geometry of the substrate to which the coating is applied, and the viscosity of the coating. Other coating methods are well known in the art and some of them may be applied to the present application.

In some embodiments, the method is performed at a temperature below 60° C., below 50° C., below 40° C., below 30° C., below 20° C., below 15° C., below 10° C., below 5° C., below 0° C., including any range therebetween. In some embodiments, the method is performed at a temperature below the boiling point of the composition. In some embodiments, the method is performed at a temperature above the melting point of the composition. Exemplary methods are described herein (Examples section).

In some embodiments, the method is devoid of a preliminary step of sonicating the composition.

In some embodiments, the method further comprises applying a vacuum after contacting the coating composition with the substrate, to remove air from the coating. In some embodiments, air removal is performed in order to obtain a uniform coating.

In some embodiments, drying is performed by convection drying, such as by applying a hot gas stream to a coated substrate. In some embodiments, drying is performed by cold drying, such as by applying a de-humidified gas stream to a coated substrate.

In some embodiments, the method further comprises vacuum drying of the coated substrate.

In some embodiments, the method further comprises firing the coated substrate at a temperature ranging from 800 to 1600° C. Such firing, also referred to as “pyrolysis” may result in partial decomposition of the silicon-based polymer, and formation of silicon carbide ceramic matrix. The silicon carbide matrix, comprising derivatized carbon nanoparticles provides enhanced stability and hardness to the coating. In some embodiments, the substrate is selected from the group comprising: a polymeric substrate, a metallic substrate, and a glass substrate or any combination thereof.

In some embodiments, the substrate comprises a polymeric substrate, a glass substrate, a ceramic substrate, a wood substrate, a paper substrate or any combination thereof. Other substrates can be coated with the composition of the invention (e.g. the liquid or the semi-solid composition). The inventors successfully implemented a large variety of substrates (e.g. a polymeric substrate such as polyethylene, a glass substrate, a ceramic substrate, a paint coated substrate) for coating with a liquid composition described herein.

Non-limiting examples of glass substrates according to the present invention comprise borosilicate-based glass substrate, silicon-based glass substrate, ceramic-based glass substrate, silica/quartz-based glass substrate, aluminosilicate-based glass substrate, and any combination thereof.

Non-limiting examples of polymeric substrates according to the present invention comprise polypropylene (PP), polycarbonate (PC), high-density polyethylene (HDPE), low-density polyethylene (LDPE), very low-density polyethylene (VLDPE), polyester, polyethylene terephthalate (PET), polycarbonate (PC), polyvinyl chloride (PVC), polymethyl methacrylate (PMMA), silicon, polyacetal, silicon rubber, cellulose, cellulose derivatives, poly(2-hydroxyethyl methacrylate) (pHEMA), nylon, and any combination thereof.

In some embodiments, the substrate has been coated with a lacquer, a varnish or a paint prior to the formation of the coating layer.

In some embodiments, the composition or the coating layer in a solution comprising solvent as described herein. In some embodiments, the solution is devoid of a curing agent, a surfactant, or a stabilizer.

In some embodiments, the resulting coated substrates are air-dried.

In some embodiments, the coating process further comprises a step of evaporating the solvent(s) mixture or coating (e.g., the mixture or coating deposited on the substrate). The step of evaporating the solvent(s) may be performed at e.g., room temperature (i.e. 15° C. to 30° C.) or at elevated temperature (i.e. up to 100° C.).

In some embodiments, the method comprises contacting a composition with a substrate, and in-situ polymerizing the composition under suitable conditions, wherein the composition comprises an amine (e.g. ammonia) and a polysiloxane and/or a silane (e.g. chloro-silane), and one or more of the derivatized carbon nano-particle. In some embodiments, the composition comprises, a polysiloxane and ammonia, wherein the ratio of polysiloxane and ammonia is sufficient to obtain polysilazane in-situ. In some embodiments, the conditions of in-situ polymerization are compatible with the one or more of the derivatized carbon nano-particle. In some embodiments, the in-situ polymerization is performed at a temperature between 1° and 600° C., between 1° and 30° C., between 3° and 100° C., between 10° and 200° C., between 20° and 400° C., between 40° and 600° C., between 60° and 800° C., between 80° and 1200° C., between 120° and 1600° C., including any range or value therebetween. In some embodiments, the in-situ polymerization is performed at a temperature up to 1000° C., up to 800° C., up to 600° C., up to 500° C., including any range or value therebetween. In some embodiments, the in-situ polymerization is performed under exposure to UV-radiation of a suitable wavelength. In some embodiments, the in-situ polymerization is performed under contacting the coating with a solution of a reducing agent (such as hydrogen peroxide or a source thereof) and subsequent or simultaneous exposure to UV-radiation of a suitable wavelength. Other polymerization techniques for obtaining polysilazane based coating are well-known in the art.

In some embodiments, the method is performed at an elevated temperature, such as at a temperature of between 6° and 800° C., between 6° and 80° C., between 8° and 100° C., between 10° and 200° C., between 20° and 300° C., between 30° and 400° C., between 40° and 500° C., between 50° and 600° C., between 60° and 700° C., between 70° and 800° C., including any range or value therebetween.

In some embodiments, the coating formed by the method of the invention performed at the elevated temperature is characterized by an enhanced strength (such as strength determined by nanoindentation as described herein). In some embodiments, enhanced strength is referred to a strength measured by nanoindentation, wherein the strength is between 5 and 15 GPa, between 5 and 7 GPa, between 7 and 10 GPa, between 10 and 15 GPa, between 15 and 20 GPa, including any range or value therebetween. In some embodiments, the strength of the coating applied at a temperature below 70° C. is between 0.1 and 4.5 GPa including any range or value therebetween.

According to an aspect of some embodiments of the present invention there is provided a method for receiving a composition comprising a substrate and a coating layer linked to a portion of at least one surface of the substrate, characterized by a water contact angle of at least 40°.

According to an aspect of some embodiments of the present invention there is provided a method for receiving a scratch resistant composition.

According to an aspect of some embodiments of the present invention there is provided a method for receiving an anti-fouling composition.

### Articles

According to an aspect of some embodiments of the present invention there is provided an article, comprising a coating layer, the coating layer comprises the composition as described herein. In some embodiments, the article is a coated article. In some embodiments, the article comprises a fragile surface. In some embodiments, deposition of a coating layer comprising the composition of the invention on variable articles resulted in imparting advantageous properties to the article's surface such as superhydrophobicity, lyophobicity, chemical resistance, scratch resistance, and hardness. In some embodiments, the article or the coated article is characterized by tribological properties, hydro and aerodynamic properties, anti-fouling and antibacterial properties, increased wear resistance, ultraviolet protection, gas barrier protection, dielectric properties, antistatic properties, anti-corrosive properties, anti-glare properties, encapsulating properties with high light transmittance or any combination thereof.

In some embodiments, the substrate incorporating the composition as described herein is or forms a part of an article.

According to another aspect of some embodiments of the present invention there is provided an article (e.g., an article-of-manufacturing) comprising a substrate incorporating in and/or on at least a portion thereof a composition-of-matter, as described in any one of the respective embodiments herein.

According to another aspect of some embodiments of the present invention there is provided an article (e.g., an article-of-manufacturing) comprising the composition of the invention.

In some embodiments, the article is selected from the group consisting of: a transparent plastic surface, a flexible plastic surface, a glass surface, a metal surface, a lens, a display, a package, a non-woven material, a fiber, a thread, a woven or a non-woven fabric, and a window.

In some embodiments, the article is, for example, article having a corrosive surface.

The article can be any article which can benefit from the anti-fogging, superhydrophobic, anti-fouling, activities of the disclosed compositions.

Exemplary articles include, but are not limited to, automotive device (e.g. a vehicle, a motor vehicle, an aircraft, a space craft, a rocket, a military vehicle, a train, a bus), medical devices, an agricultural device, a package, a sealing article, a fuel container, and a construction element or any part and/or a combination thereof.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

As used herein, the term “alkyl” alone or in combination refers to a straight, branched, or cyclic chain containing at least one carbon atom and no double or triple bonds between carbon atoms. As used herein, the term “lower alkyl” refers to a C₁-C₆ alkyl. In certain embodiments, an alkyl contains 1 to 20 carbon atoms (whenever it appears herein, a numerical range such as “1 to 20” refers to each integer in the given range; e.g., “1 to 20 carbon atoms” means that an alkyl group can contain only 1 carbon atom, 2 carbon atoms, 3 carbon atoms, etc., up to and including 20 carbon atoms, although the term “alkyl” also includes instances where no numerical range of carbon atoms is designated). In certain embodiments, an alkyl contains 1 to 10 carbon atoms. In certain embodiments, an alkyl contains 1 to 8 carbon atoms. An alkyl can be designated as “C₁-C₄ alkyl” or similar designations. By way of example only, “C₁-C₄ alkyl” indicates an alkyl having one, two, three, or four carbon atoms, i.e., the alkyl is selected from among methyl, ethyl, propyl, iso-propyl, n-butyl, iso-butyl, sec-butyl and t-butyl. Thus C₁-C₄ includes C₁-C₂ and C₁-C₃alkyl. Alkyls can be substituted or unsubstituted. Alkyls include, but are not limited to, methyl, ethyl, propyl, isopropyl, butyl, isobutyl, tertiary butyl, pentyl, hexyl, ethenyl, propenyl, butenyl, cyclopropyl, cyclobutyl, cyclopentyl, and cyclohexyl, each of which optionally are substituted.

As used herein, the term “alkenyl” alone or in combination refers to an alkyl containing at least two carbon atoms and at least one carbon-carbon double bond (an alkene group). In certain embodiments, alkenyls are optionally substituted. As used herein, the term “alkynyl” alone or in combination refers to an alkyl containing at least two carbon atoms and at least one carbon-carbon triple bond (an alkyne group). In certain embodiments, alkynyls are optionally substituted.

As used herein, the term “halo” or “halogen” refers to an element in Group VIIA of the periodic table having seven valence electrons. Exemplary halogens include fluorine, chlorine, bromine and iodine.

As used herein, the term “haloalkyl” alone or in combination refers to an alkyl in which at least one hydrogen atom is replaced with a halogen atom. In certain of the embodiments in which two or more hydrogen atom are replaced with halogen atoms, the halogen atoms are all the same as one another. In certain of such embodiments, the halogen atoms are not all the same as one another. Certain haloalkyls are saturated haloalkyls, which do not include any carbon-carbon double bonds or any carbon-carbon triple bonds. Certain haloalkyls are haloalkenes, which include one or more carbon-carbon double bonds. Certain haloalkyls are haloalkynes, which include one or more carbon-carbon triple bonds. In certain embodiments, haloalkyls are optionally substituted. Where the number of any given substituent is not specified (e.g., “haloalkyl”), there can be one or more substituents present. For example, “haloalkyl” can include one or more of the same or different halogens. For example, “haloalkyl” includes each of the substituents CF₃, CHF₂ and CH₂F.

As used herein, the term “heteroalkyl” alone or in combination refers to a group containing an alkyl and one or more heteroatoms. Certain heteroalkyls are saturated heteroalkyls, which do not contain any carbon-carbon double bonds or any carbon-carbon triple bonds. Certain heteroalkyls are heteroalkenes, which include at least one carbon-carbon double bond. Certain heteroalkyls are heteroalkynes, which include at least one carbon-carbon triple bond. Certain heteroalkyls are acylalkyls, in which the one or more heteroatoms are within an alkyl chain. Examples of heteroalkyls include, but are not limited to, CH₃C(═O)CH₂—, CH₃C(═O)CH₂CH₂—, CH₃CH₂C(═O)CH₂CH₂, CH₃C(═O)CH₂CH₂CH₂—, CH₃OCH₂CH₂—, CH₃C(═O)CH₂ and CH₃NHCH₂—. In certain embodiments, heteroalkyls are optionally substituted.

As used herein, the term “heterohaloalkyl” alone or in combination refers to a heteroalkyl in which at least one hydrogen atom is replaced with a halogen atom. In certain embodiments, heteroalkyls are optionally substituted.

As used herein, the term “ring” refers to any covalently closed structure. Rings include, for example, carbocycles (e.g., aryls and cycloalkyls), heterocycles (e.g., heteroaryls and non-aromatic heterocycles), aromatics (e.g., aryls and heteroaryls), and non-aromatics (e.g., cycloalkyls and non-aromatic heterocycles). Rings can be optionally substituted. Rings can form part of a ring system.

As used herein, the term “ring system” refers to two or more rings, wherein two or more of the rings are fused. The term “fused” refers to structures in which two or more rings share one or more bonds.

As used herein, the term “heterocycle” refers to a ring wherein at least one atom forming the ring is a carbon atom and at least one atom forming the ring is a heteroatom. Heterocyclic rings can be formed by three, four, five, six, seven, eight, nine, or more than nine atoms. Any number of those atoms can be heteroatoms (i.e., a heterocyclic ring can contain one, two, three, four, five, six, seven, eight, nine, or more than nine heteroatoms, provided that at least one atom in the ring is a carbon atom). Herein, whenever the number of carbon atoms in a heterocycle is indicated (e.g., C₁-C₆ heterocycle), at least one other atom (the heteroatom) must be present in the ring. Designations such as “C₁-C₆ heterocycle” refer only to the number of carbon atoms in the ring and do not refer to the total number of atoms in the ring. It is understood that the heterocyclic ring will have additional heteroatoms in the ring. Designations such as “4-6 membered heterocycle” refer to the total number of atoms that comprise the ring (i.e., a four, five, or six membered ring, in which at least one atom is a carbon atom, at least one atom is a heteroatom and the remaining two to four atoms are either carbon atoms or heteroatoms). In heterocycles containing two or more heteroatoms, those two or more heteroatoms can be the same or different from one another. Heterocycles can be optionally substituted. Binding to a heterocycle can be at a heteroatom or via a carbon atom As used herein, the term “carbocycle” refers to a ring, where each of the atoms forming the ring is a carbon atom. Carbocyclic rings can be formed by 3, 4, 5, 6, 7, 8, 9, or more than 9 carbon atoms. Carbocycles can be optionally substituted.

As used herein, the term “heteroatom” refers to an atom other than carbon or hydrogen. Heteroatoms are typically independently selected from oxygen, sulfur, nitrogen and phosphorus, but are not limited to those atoms. In embodiments in which two or more heteroatoms are present, the two or more heteroatoms can all be the same as one another, or some or all of the two or more heteroatoms can each be different from the others.

As used herein, the term “bicyclic ring” refers to two rings, where the two rings are fused. Bicyclic rings include, e.g., decaline, pentalene, indene, naphthalene, azulene, heptalene, isobenzofuran, chromene, indolizine, isoindole, indole, indoline, purine, quinolizine, isoquinoline, quinoline, phthalazine, naphthyrididine, quinoxaline, cinnoline, pteridine, isochroman, chroman and various hydrogenated derivatives thereof. Bicyclic rings can be optionally substituted. Each ring is independently aromatic or non-aromatic. In certain embodiments, both rings are aromatic. In certain embodiments, both rings are non-aromatic. In certain embodiments, one ring is aromatic, and one ring is non-aromatic.

As used herein, the term “aromatic” refers to a planar ring having a delocalized π-electron system containing 4n+2 π electrons, where n is an integer. Aromatic rings can be formed by five, six, seven, eight, nine, or more than nine atoms. Aromatics optionally can be substituted. Examples of aromatic groups include, but are not limited to, phenyl, tetralinyl, naphthalenyl, phenanthrenyl, anthracenyl, fluorenyl, indenyl and indanyl. The teem aromatic includes, e.g., benzenoid groups, connected via one of the ring-forming carbon atoms, and optionally carrying one or more substituents selected from an aryl, a heteroaryl, a cycloalkyl, a non-aromatic heterocycle, a halo, a hydroxy, an amino, a cyano, a nitro, an alkylamido, an acyl, a C₁₋₆alkoxy, a C₁₋₆alkyl, a C₁₋₆ hydroxyalkyl, a C₁₋₆ aminoalkyl, a C₁₋₆ alkylamino, an alkylsulfenyl, an alkylsulfinyl, an alkylsulfonyl, an sulfamoyl, or a trifluoro-methyl. In certain embodiments, an aromatic group is substituted at one or more of the para, meta, and/or ortho positions. Examples of aromatic groups containing substitutions include, but are not limited to, phenyl, 3-halophenyl, 4-halophenyl, 3-hydroxyphenyl, 4-hydroxy-phenyl, 3-aminophenyl, 4-aminophenyl, 3-methylphenyl, 4-methylphenyl, 3-methoxyphenyl, 4-methoxyphenyl, 4-trifluoromethoxyphenyl, 3-cyano-phenyl, 4-cyanophenyl, naphthyl, dimethylphenyl, hydroxynaphthyl, hydroxymethyl-phenyl, (trifluoromethyl)phenyl, alkoxyphenyl, 4-morpholin-4-ylphenyl, 4-pyrrolidin-1-ylphenyl, 4-pyrazolylphenyl, 4-triazolylphenyl and 4-(2-oxopyrrolidin-1-yl)phenyl.

As used herein, the term “aryl” refers to a monocyclic, bicyclic or tricyclic aromatic system that contains no ring heteroatoms. Where the systems are not monocyclic, the term aryl includes for each additional ring the saturated form (perhydro form) or the partially unsaturated form (for example the dihydro form or tetrahydro form) or the maximally unsaturated (nonaromatic) form. In some embodiments, the term aryl refers to bicyclic radicals in which the two rings are aromatic and bicyclic radicals in which only one ring is aromatic. Examples of aryl include phenyl, naphthyl, anthracyl, indanyl, 1,2-dihydro-naphthyl, 1,4-dihydronaphthyl, indenyl, 1,4-naphthoquinonyl and 1,2,3,4-tetrahydronaphthyl.

Aryl rings can be formed by three, four, five, six, seven, eight, nine, or more than nine carbon atoms. In some embodiments, aryl refers to a 3-, 4-, 5-, 6-, 7-, 8-, 9-, 10-, 11-, 12-, 13- or 14-membered, aromatic mono-, bi- or tricyclic system. In some embodiments, aryl refers to an aromatic C₃-C₉ ring. In some embodiments, aryl refers to an aromatic C₄-C₈ ring. Aryl groups can be optionally substituted.

As used herein, the term “heteroaryl” refers to an aromatic ring in which at least one atom forming the aromatic ring is a heteroatom. Heteroaryl rings can be foamed by three, four, five, six, seven, eight, nine and more than nine atoms. Heteroaryl groups can be optionally substituted. Examples of heteroaryl groups include, but are not limited to, aromatic C₃₋₈ heterocyclic groups containing one oxygen or sulfur atom, or two oxygen atoms, or two sulfur atoms or up to four nitrogen atoms, or a combination of one oxygen or sulfur atom and up to two nitrogen atoms, and their substituted as well as benzo- and pyrido-fused derivatives, for example, connected via one of the ring-forming carbon atoms. In certain embodiments, heteroaryl is selected from among oxazolyl, isoxazolyl, oxadiazolyl, thiazolyl, isothiazolyl, pyridinyl, pyridazinyl, pyrimidinal, pyrazinyl, indolyl, benzimidazolyl, quinolinyl, isoquinolinyl, quinazolinyl or quinoxalinyl.

In some embodiments, a heteroaryl group is selected from among pyrrolyl, furanyl (furyl), thiophenyl (thienyl), imidazolyl, pyrazolyl, 1,2,3-triazolyl, 1,2,4-triazolyl, 1,3-oxazolyl (oxazolyl), 1,2-oxazolyl (isoxazolyl), oxadiazolyl, 1,3-thiazolyl (thiazolyl), 1,2-thiazolyl (isothiazolyl), tetrazolyl, pyridinyl (pyridyl)pyridazinyl, pyrimidinyl, pyrazinyl, 1,2,3-triazinyl, 1,2,4-triazinyl, 1,3,5-triazinyl, 1,2,4,5-tetrazinyl, indazolyl, indolyl, benzothiophenyl, benzofuranyl, benzothiazolyl, benzimidazolyl, benzodioxolyl, acridinyl, quinolinyl, isoquinolinyl, quinazolinyl, quinoxalinyl, phthalazinyl, thienothiophenyl, 1,8-naphthyridinyl, other naphthyridinyls, pteridinyl or phenothiazinyl. Where the heteroaryl group includes more than one ring, each additional ring is the saturated form (perhydro form) or the partially unsaturated form (e.g., the dihydro form or tetrahydro form) or the maximally unsaturated (nonaromatic) form. The term heteroaryl thus includes bicyclic radicals in which the two rings are aromatic and bicyclic radicals in which only one ring is aromatic. Such examples of heteroaryl are include 3H-indolinyl, 2(1H)-quinolinonyl, 4-oxo-1,4-dihydroquinolinyl, 2H-1-oxoisoquinolyl, 1,2-dihydroquinolinyl, (2H)quinolinyl N-oxide, 3,4-dihydroquinolinyl, 1,2-dihydroisoquinolinyl, 3,4-dihydro-isoquinolinyl, chromonyl, 3,4-dihydroiso-quinoxalinyl, 4-(3H)quinazolinonyl, 4H-chromenyl, 4-chromanonyl, oxindolyl, 1,2,3,4-tetrahydroisoquinolinyl, 1,2,3,4-tetrahydro-quinolinyl, 1H-2,3-dihydroisoindolyl, 2,3-dihydrobenzo[f]isoindolyl, 1,2,3,4-tetrahydrobenzo-[g]isoquinolinyl, 1,2,3,4-tetrahydro-benzo[g]isoquinolinyl, chromanyl, isochromanonyl, 2,3-dihydrochromonyl, 1,4-benzo-dioxanyl, 1,2,3,4-tetrahydro-quinoxalinyl, 5,6-dihydro-quinolyl, 5,6-dihydroiso-quinolyl, 5,6-dihydroquinoxalinyl, 5,6-dihydroquinazolinyl, 4,5-dihydro-1H-benzimidazolyl, 4,5-dihydro-benzoxazolyl, 1,4-naphthoquinolyl, 5,6,7,8-tetrahydro-quinolinyl, 5,6,7,8-tetrahydro-isoquinolyl, 5,6,7,8-tetrahydroquinoxalinyl, 5,6,7,8-tetrahydroquinazolyl, 4,5,6,7-tetrahydro-1H-benzimidazolyl, 4,5,6,7-tetrahydro-benzoxazolyl, 1H-4-oxa-1,5-diaza-naphthalen-2-onyl, 1,3-dihydroimidizolo-[4,5]-pyridin-2-onyl, 2,3-dihydro-1,4-dinaphtho-quinonyl, 2,3-dihydro-1H-pyrrol[3,4-b]quinolinyl, 1,2,3,4-tetrahydrobenzo[b]-[1,7]naphthyridinyl, 1,2,3,4-tetra-hydrobenz[b][1,6]-naphthyridinyl, 1,2,3,4-tetrahydro-9H-pyrido[3,4-b]indolyl, 1,2,3,4-tetrahydro-9H-pyrido[4,3-b]indolyl, 2,3-dihydro-1H-pyrrolo-[3,4-b]indolyl, 1H-2,3,4,5-tetrahydro-azepino[3,4-b]indolyl, 1H-2,3,4,5-tetrahydroazepino-[4,3-b]indolyl, 1H-2,3,4,5-tetrahydro-azepino[4,5-b]indolyl, 5,6,7,8-tetrahydro[1,7]napthyridinyl, 1,2,3,4-tetrahydro-[2,7]-naphthyridyl, 2,3-dihydro[1,4]dioxino[2,3-b]pyridyl, 2,3-dihydro[1,4]-dioxino[2,3-b]pryidyl, 3,4-dihydro-2H-1-oxa[4,6]diazanaphthalenyl, 4,5,6,7-tetrahydro-3H-imidazo-[4,5-c]pyridyl, 6,7-dihydro[5,8]diazanaphthalenyl, 1,2,3,4-tetrahydro[1,5]-napthyridinyl, 1,2,3,4-tetrahydro[1,6]napthyridinyl, 1,2,3,4-tetrahydro[1,7]napthyridinyl, 1,2,3,4-tetrahydro-[1,8]napthyridinyl or 1,2,3,4-tetrahydro[2,6]napthyridinyl. In some embodiments, heteroaryl groups are optionally substituted. In one embodiment, the one or more substituents are each independently selected from among halo, hydroxy, amino, cyano, nitro, alkylamido, acyl, C₁₋₆-alkyl, C₁₋₆-haloalkyl, C₁₋₆-hydroxyalkyl, C₁₋₆-aminoalkyl, C₁₋₆-alkylamino, alkylsulfenyl, alkylsulfinyl, alkylsulfonyl, sulfamoyl, or trifluoromethyl.

Examples of heteroaryl groups include, but are not limited to, unsubstituted and mono- or di-substituted derivatives of furan, benzofuran, thiophene, benzothiophene, pyrrole, pyridine, indole, oxazole, benzoxazole, isoxazole, benzisoxazole, thiazole, benzothiazole, isothiazole, imidazole, benzimidazole, pyrazole, indazole, tetrazole, quinoline, isoquinoline, pyridazine, pyrimidine, purine and pyrazine, furazan, 1,2,3-oxadiazole, 1,2,3-thiadiazole, 1,2,4-thiadiazole, triazole, benzotriazole, pteridine, phenoxazole, oxadiazole, benzopyrazole, quinolizine, cinnoline, phthalazine, quinazoline and quinoxaline. In some embodiments, the substituents are halo, hydroxy, cyano, O—C₁₋₆-alkyl, C₁₋₆-alkyl, hydroxy-C₁₋₆-alkyl and amino-C₁₋₆-alkyl.

As used herein, the term “arylalkyl” alone or in combination, refers to an alkyl substituted with an aryl that can be optionally substituted.

As used herein, the term “non-aromatic ring” refers to a ring that does not have a delocalized 4n+2 π-electron system.

As used herein, the term “cycloalkyl” refers to a group containing a non-aromatic ring wherein each of the atoms forming the ring is a carbon atom. Cycloalkyls can be formed by three, four, five, six, seven, eight, nine, or more than nine carbon atoms. Cycloalkyls can be optionally substituted. In certain embodiments, a cycloalkyl contains one or more unsaturated bonds. Examples of cycloalkyls include, but are not limited to, cyclopropane, cyclobutane, cyclopentane, cyclopentene, cyclopentadiene, cyclohexane, cyclohexene, 1,3-cyclohexadiene, 1,4-cyclohexadiene, cycloheptane and cycloheptene.

As used herein, the term “arylalkyl” alone or in combination, refers to an alkyl substituted with an aryl that can be optionally substituted.

As used herein, the term “heteroarylalkyl” alone or in combination, refers to an alkyl substituted with a heteroaryl that can be optionally substituted.

As used herein, the term “alkyl”, “alkenyl” and “alkynyl” as well as derivative terms such as “alkoxy”, “acyl”, “alkylthio” and “alkylsulfonyl” include linear, branched and cyclic groups within their scope. The term “alkenyl” and “alkynyl” is intended to include one or more unsaturated bonds.

As used herein, the term “thioalkoxy” refers to —S— group, also known as thio or alkylthio.

As used herein, the term “ester” refers to a chemical moiety with formula —(R)ₙ—COOR′, where R and R′ are independently selected from alkyl, cycloalkyl, aryl, heteroaryl (bonded through a ring carbon) and non-aromatic heterocycle (bonded through a ring carbon), where n is 0 or 1.

As used herein, the term “amide” refers to a chemical moiety with formula —(R)ₙ—C(O)NHR′ or —(R)ₙ—NHC(O)R′, where R and R′ are independently selected from alkyl, cycloalkyl, aryl, heteroaryl (bonded through a ring carbon) and heteroalicyclic (bonded through a ring carbon), where n is 0 or 1. In certain embodiments, an amide can be an amino acid or a peptide.

Unless otherwise indicated, the term “optionally substituted,” refers to a group in which none, one, or more than one of the hydrogen atoms has been replaced with one or more group(s) individually and independently selected from among alkyl, cycloalkyl, aryl, heteroaryl, hydroxy, alkoxy, aryloxy, halo, carbonyl, azido, oxo, cyano, cyanato, carboxy, isocyanato, thiocyanato, isothiocyanato, nitro, silyl, and mono- and di-substituted amino groups.

As used herein, the terms “silicon” and “siloxane” are synonymous. As used herein, the term “siloxane” refers to a class of compounds that include alternate silicon and oxygen atoms, and can include carbon and hydrogen atoms. A siloxane contains a repeating silicon-oxygen backbone and can include organic groups (R) attached to a significant proportion of the silicon atoms by silicon-carbon bonds. In commercial silicons most R groups are methyl; longer alkyl, fluoroalkyl, phenyl, vinyl, and a few other groups are substituted for specific purposes. Some of the R groups also can be hydrogen, chlorine, alkoxy, acyloxy, or alkylamino. These polymers can be combined with fillers, additives, and solvents to result in products classed as silicons. See Kirk-Othmer Encyclopedia of Polymer Science and Technology, Volume 15, John Wiley & Sons, Inc. (New York: 1989), pages 204-209, 234-265, incorporated herein by reference. The siloxanes include any organosilicon polymers or oligomers having a linear or cyclic, branched or crosslinked structure, of variable molecular weight, and essentially based on recurring structural units in which the silicon atoms are linked to each other by oxygen atoms (—Si—O—Si—), and where optionally substituted, substituents can be linked via a carbon atom to the silicon atoms.

As used herein, the term “polysiloxane” refers to a polymeric material that includes siloxane units, where the Si atom can include alkyl or aryl substituents. For example, a polymer that includes (R₂SiO), where R is methyl is known as a methylsiloxane or dimethylsiloxane.

As used herein, the term “cyclosiloxane” refers to a cyclic siloxane.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “substantially” refers at least 60%, at least 70%, at least 80%, at least 85%, at least 90%, at least 95%, at least 97%, at least 99%, at least 99.9%, including any rage or value therebetween. In some embodiments, the terms “substantially” and the term “consisting essentially of” are used herein interchangeably.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

Various embodiments and aspects of the present invention as delineated hereinabove and as claimed in the claims section below find experimental support in the following examples. Reference is now made to the following examples, which together with the above descriptions illustrate some embodiments of the invention in a non-limiting fashion.

### Materials

### Nanodiamonds:

High quality nanodiamond powder was purchased from pDiamond® Vox P, Carbodeon Oy, Finland.

Nanodiamonds were transferred to the Swiss company NGNT LLC for their purification and fluorination. Nanodiamonds were additionally purified from impurities according to a standard procedure. The size of nanodiamonds was reduced to a substantially uniform value (2-5 nm). Fluorination of nanodiamonds was performed using NGNT LLC technology.

### Single-Walled Carbon Nanotubes:

Single-walled carbon nanotubes were purchased from OCSiAL (Luxembourg) of the brand TUBALL™ (outer tube diameter 1.2-2.0 nm, length up to 5 μm). The nanotubes were transferred for fluorination and dispersion to the Swiss company NGNT LLC. NGNT LLK fluorinated nanodiamonds and fluorinated nanotubes were dispersed in a hydrocarbon solvent (e.g. xylene). Alternatively, ND and SWCNTs were fluorinated according to an in-house procedure.

Perhydrosilazane (PHPS/inorganic polysilazane) brand Durazane 2850 (old name NN 120-20A) (manufactured in Japan) was purchased from Merck Group (Germany) and was used in the form in which it was received.

Quantum dots (having an initiation wavelength between 300 and 400 nm were purchased from NIIPA (Dubna, Russia) and were admixed to a liquid dispersion comprising F-ND and/or F-SWCNT in a suitable aliphatic and/or aromatic hydrocarbon solvent.

### Methods

An exemplary method of manufacturing an exemplary composition according to the invention is as follows: the fluorinated composition of nanocarbon elements was dispersed in an aromatic solvent such xylene. The resulting composition was dispersed using an ultrasonic bath in a solution of dibutyl ether-based perhydrosilazane.

An exemplary method of coating a substrate with of the invention is as follows:

Several standard coating methods have been implemented (such as spin coating, spray coating and brush coating). Preference was given to applying from a spray gun to a pre-defatted substrate.

Hardness and Young's modulus has been measured as follows:

Measurement of hardness in the nanoscale and Young's modulus of elasticity using the Oliver-Farr method. Mechanical properties (hardness and Young's modulus of elasticity) were measured using a Nanovea nanoscale hardness tester (USA) The indenter was the Berkovich indenter, which is a trihedral diamond pyramid, since the indenter radius of curvature significantly affects the accuracy of the method. The nonideality of the indenter shape was taken into account by means of preliminary calibration and calculation of the correction coefficients Ci.

Table 1 represents a summary of experimental compositions utilizing various w/w concentrations [% w/w] of fluorinated carbon nano-particles (nano-diamonds, [F-ND]; or SWCNT [F-CNT], including atomic percentage of fluorine within the fluorinated carbon nano-particles [at. % (F)]) and perhydrosilazane (PHPS) in the final coating.

TABLE 1

| | F-CNT | F-ND | | | | | |
|---|---|---|---|---|---|---|---|
| | (at. % (F)/ | (% (F)/ | PHPS | Dispersion | | Coating | |
| | % w/w) | % w/w) | (% w/w) | stability | | method | Effect |
| Composition 1 | 20/0.05 | 40/0.05 | 1.5 | >60 | days | dipping, | the coating showed a |
| | | | | | | spray gun | slight change in |
| | | | | | | | hydrophobicity and |
| | | | | | | | not a significant |
| | | | | | | | change in physico- |
| | | | | | | | mechanical properties |
| Composition 2 | 20/0.01 | 60/0.01 | 1.5 | >60 | days | dipping, | the coating showed high |
| | | | | | | spray gun | dispersion stability, |
| | | | | | | | significant hydrophobicity |
| | | | | | | | and oleophobicity, an |
| | | | | | | | increase in physical and |
| | | | | | | | mechanical properties, but |
| | | | | | | | without loss of transparency |
| Composition 3 | 0 | 0/0.2 | 2 | <10 | days | dipping, | the coating showed a |
| | | | | | | spray gun | slight change in |
| | | | | | | | hydrophobicity and |
| | | | | | | | not a significant |
| | | | | | | | change in physico- |
| | | | | | | | mechanical properties |
| Composition 4 | 0/0.01 | 0 | 5 | <10 | days | dipping, | the coating showed a |
| | | | | | | spray gun | slight change in |
| | | | | | | | hydrophobicity and |
| | | | | | | | not a significant |
| | | | | | | | change in physico- |
| | | | | | | | mechanical properties |
| Composition 5 | 0 | 10/0.01 | 5 | 10 | day | dipping, | the coating showed low |
| | | | | | | spray gun | dispersion stability |
| | | | | | | | and a slight shift in |
| | | | | | | | hydrophobicity and |
| | | | | | | | a change in physical |
| | | | | | | | and mechanical properties |
| | | | | | | | (within the error) |
| Composition 6 | 10/68 | 20/2 | 15 | 5 | days | dipping, | Elastic, hydrophobic, |
| | | | | | | pressing | highly light absorbing |
| | | | | | | (molding), | opaque coating with |
| | | | | | | deposition, | electrically conductive |
| | | | | | | spray gun | and thermally conductive |
| | | | | | | | properties |
| Composition 7 | 50/70 | 40/5 | 10 | 2 | days | dipping, | coating showed low |
| | | | | | | pressing | dispersion stability, |
| | | | | | | (molding), | high critical viscosity |
| | | | | | | deposition, | for any application or |
| | | | | | | spray gun | practical application |

Table 2 represents a summary of mechanical properties of various compositions compared to control. Thickness is referred to a maximum thickness resulting in a stable coating (e.g. coating being substantially devoid of cracks and deformations)

TABLE 2

| | | Young's | Hard- | Water |
|---|---|---|---|---|
| | | Modulus | ness | contact |
| | Thickness (um) | (GPa) | (GPa) | angle |
| Control | 0.8 | 34 | 3.2 | 17.5 |
| (perhydrosilazane | (stable film, | | | |
| (1.5% w/v), without | embrittlement | | | |
| nano additive) Room | threshold at a | | | |
| temperature for | thickness of | | | |
| a month | more than 1.5-2 | | | |
| | microns) | | | |
| Composition 1 | 1 | 60 | 3.5 | 60 |
| (perhydrosilazane | (stable film with | | | |
| (1.5% w/v), and | embrittlement | | | |
| a mixture of F-ND | threshold with a | | | |
| (0.1% w/v) and F-CNT | thickness of | | | |
| (0.1% w/v). Stable at | more than 2-2.5 | | | |
| room temperature | microns) | | | |
| for at least one month | | | | |
| Composition 2 | 1-10 | 141 | 4.5 | 105 |
| (perhydrosilazane | (stable flexible | | | |
| (1.5% w/v), and | film without | | | |
| a mixture of F-ND | cracks) | | | |
| (0.2% w/v) and F-CNT | | | | |
| (0.2% w/v). Stable at | | | | |
| room temperature for | | | | |
| at least one month | | | | |

Exemplary compositions (Table 2) showed hardness increase from 3.2 GPa to 4.5 GPa, and Young's modulus increase from 34 GPa to 60 GPa or to 141 GPa, compared to the control. Exemplary compositions of the invention (e.g. comprising 10% w/v of perhydrosilazane and one or more of fluorinated carbon nano-particles at the concentrations described herein) resulted in a matt coating layer. Exemplary compositions of the invention (e.g. comprising up to 5% w/v of perhydrosilazane and one or more of fluorinated carbon nano-particles at the concentrations described herein) resulted in a transparent coating layer.

Additionally, exemplary compositions of the invention (e.g. compositions 1 and 2 described herein) were stable (e.g. substantially devoid of cracks) upon application of 6-8 subsequent layers, compared to the control exhibiting cracks after application of only two coating layers (data not shown). Moreover, the resulting coating was flexible, being stable (e.g. substantially devoid of cracks or other surface defects) upon bending of the coated substrate.

Other compositions comprising greater concentrations of derivatized carbon nano-particles and/or of the silicone based polymer are currently under study.

1. A composition, comprising: a silicon-based polymer, and a derivatized carbon nano-particle, wherein said derivatized carbon nano-particle comprises a functional moiety attached to the derivatized carbon nano-particle by a covalent bond, and wherein said silicon-based polymer is represented by Formula 1: 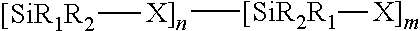
wherein:
n and m are integers ranging from 100 to 150000;
X is selected from N and N;
R₁, R₂ or both are selected from the group comprising: hydrogen, an alkyl group, an alkoxy group, a thioalkoxy group, an aryl group, a fused ring, an alkaryl group, a heteroaryl group, a cycloalkyl group, an aryloxy group, a thioaryloxy group, an ether group, and a halo group or any combination thereof.

2. The composition of claim 1, wherein said functional moiety is selected from the group comprising: a halo group, a haloalkyl group, hydrogen, a hydroxy group, a mercapto group, an amino group, an aryl group, an alkyl group, a cycloalkyl group, an alkaryl group, an ether group, and a hydrophobic polymer or any combination thereof.

3. The composition of claim 1, wherein R₁, R₂ or both are selected from the group comprising: hydrogen, fluorine, an alkyl group, an aryl group, a heteroaryl group, and a cycloalkyl group or any combination thereof.

4. The composition of claim 1, wherein said silicon-based polymer comprises an adhesiveness property to a surface, and wherein said adhesiveness property comprises a covalent or a non-covalent bond formation.

5. The composition of claim 1, wherein said silicon-based polymer has a molecular weight ranging from 150 to 150000 g/mol, and wherein said functional moiety comprises a halo group, or a haloalkyl group, optionally wherein said functional moiety is fluoro.

6. The composition of claim 1, wherein said derivatized carbon nano-particle is characterized by a median particle size of 1 to 600 nm; wherein said derivatized carbon nano-particle is selected from the group comprising: a derivatized nano-tube, a derivatized nano-rod, a derivatized nano-diamond or any combination thereof; optionally wherein said composition comprises a plurality of distinct derivatized carbon nano-particles.

7. The composition of claim 1, wherein a substitution degree of said derivatized carbon nano-particle is between 10 and 99.9 atomic percent, and wherein said derivatized carbon nano-particle is characterized by a surface water contact angle of more than 40°.

8. The composition of claim 1, wherein a weight per weight (w/w) concentration of said silicon-based polymer within said composition is 0.01 to 90%; and wherein a w/w concentration of said derivatized carbon nano-particle within said composition is 0.001 to 70%.

9. The composition of claim 1, wherein said silicon-based polymer is perhydrosilazane, and wherein said derivatized carbon nano-particle comprises a fluorinated nano-diamond, a fluorinated SWCNT or both.

10. The composition of claim 1, further comprising a solvent which is inert to said silicon-based polymer, wherein said solvent is selected from an aromatic solvent, and an aliphatic solvent or any combination thereof.

11. A coated substrate, comprising a substrate, a silicon-based polymer, and a derivatized carbon nano-particle, wherein said silicon-based polymer is bound to at least a portion of said substrate, said derivatized carbon nano-particle is in contact with said silicon-based polymer, and wherein said derivatized carbon nano-particle and said silicon-based polymer are forming one or more coating layer(s), optionally wherein said coated substrate is a part of an article comprising a fragile surface, a flexible surface, an expandable surface or any combination thereof.

12. The coated substrate of claim 11, wherein each coating layer is characterized by an average thickness of 0.1 μm to 400 μm.

13. The coated substrate of claim 11, wherein said silicon-based polymer comprises perhydrosilazane, and said derivatized carbon nano-particle comprises a fluorinated nano-diamond, a fluorinated SWCNT or both.

14. The coated substrate of claim 11, wherein said coating layer is characterized by a surface water contact angle of more than 40°, and is further characterized by at least one of: hardness of between 0.1 and 15 GPa, wherein said hardness is measured by nanoindentation according to ISO 14577 test; stability at a temperature of up to 1500° C.

15. The coated substrate of claim 11, wherein said substrate is selected from the group comprising: a polymeric substrate, a metallic substrate, a paper substrate, a wood substrate and a glass substrate or any combination thereof; and wherein said substrate is optionally coated with a lacquer, a varnish or a paint.

16. A method of coating a substrate, comprising the steps of:
i) providing a substrate;
ii) contacting said substrate with the composition of claim 1, thereby forming a coating layer on said substrate.

17. The method of claim 16, wherein said contacting is selected from the group comprising: dipping, spraying, spreading, casting, rolling, adhering, and curing or any combination thereof; and wherein said substrate is selected from the group comprising: a polymeric substrate, a metallic substrate, a ceramic substrate, and a glass substrate or any combination thereof; optionally wherein said substrate is further coated with a lacquer, a varnish or a paint.
